(19) United States
(12) Patent Application Publication
(10) Pub. No.: US 2014/0113093 A1
(43) Pub. Date: Apr. 24, 2014

(54) Polymers with reduced estrogenic activity

(71) Applicant: SOLVAY SPECIALITY POLYMERS USA, LLC, Alpharetta, GA (US)

(72) Inventors: George A. Corbin, Alpharetta, GA (US); Theodore Moore, Cumming, GA (US); Atul Bhatnagar, Alpharetta, GA (US)

(73) Assignee: SOLVAY SPECIALITY POLYMERS USA, LLC, Alpharetta, GA (US)

(21) Appl. No.: 14/119,467

(22) PCT Filed: May 24, 2012
(86) PCT No.: PCT/EP2012/059775

§ 371 Date: Nov. 22, 2013

Related U.S. Application Data
(60) Provisional application No. 61/489,955, filed on May 25, 2011.
(60) Provisional application No. 61/494,567, filed on Jun. 8, 2011.

(30) Foreign Application Priority Data
Sep. 20, 2011 (EP) 11182062.7

(51) Int. Cl. C08G 79/04; C08G 75/23

(52) U.S. Cl. CPC C08G 79/04; C08G 75/23
USPC 428/36.9; 528/174; 528/169; 521/180; 568/638; 264/177.1; 428/182; 428/398

(57) ABSTRACT

A polymer which comprises recurring units derived from at least one monomer (M) having a general formula (I) Y₁—Z₁-Q-Z₂—Y₂ wherein Y₁ and Y₂, equal or different from each other, are independently selected from a group consisting of OH, SH, Cl, Br, NO₂ or I; Z₁ and Z₂, equal or different from each other, independently comprises at least 1 aromatic ring and, Q comprises at least one hydrophilic moiety (H) selected from the group consisting of a sulfone (SO₂), a ketone (CO), a phosphine oxide (PO), an ether, a thioether, an ester, an anhydride, a carbonate, an amide, an imide, an imine and an urethane group, and the interatomic distance between Y₁ and Y₂ is at least 10 Å, the monomer has an EC₅₀ response value to the estrogen receptor a (ERα) equal to or at least 26000 nM.

This application claims priority to U.S. application No. 61/489,955 filed on 25 May 2011, to U.S. application No. 61/494,567 filed on 8 Jun. 2011—and to EP 11182062.7 filed 20 Sep. 2011, the whole content of each of these applications being incorporated herein by reference for all purposes.

### FIELD OF THE INVENTION

The invention relates to new polymers having reduced estrogenic activity. The invention further relates to compositions containing such polymers, and articles made from such polymers.

### DESCRIPTION OF THE RELATED ART

Polymeric materials are known for their diversity in terms of chemical composition, properties and applications, and are widely distributed in the society and the environment. Plastics offer a lot of benefits for human health and the environment, for instance plastic packaging protects food from contamination, light polymeric materials (replacing metals) in cars and aircraft save fuel; polymeric products used for medical applications contribute to improved health (e.g. blood pouches, tubings, disposable syringes, prosthesis) and many other benefits.

For example, poly(aryl ether sulfones) have been utilized for making products in different fields of applications, for instance in the medical market, such as membranes due to their excellent mechanical and thermal properties, coupled with outstanding hydrolytic stability. Poly(arylethersulfone) is a generic term used to describe any polymer containing at least one ether group (—O—), at least one sulfone group (—SO₂—) and at least one arylene group.

A commercially important group of poly(arylethersulfones) includes polysulfone polymers identified herein as PSU. PSU contains reacted units of diphenyl sulfone and bisphenol A (BPA). Such PSU is commercially available from Solvay Advanced Polymers (i.e., under the trademark UDEL®). The structure of the repeating units of a UDEL polysulfone, made by condensing bisphenol A (BPA) and 4,4′-dichlorodiphenyl sulfone (DCDPS), is shown below:

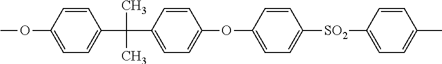

PSU has a high glass transition temperature (e.g., about 185° C.) and exhibits high strength and toughness.

GB 1 306 464 describes a poly(arylethersulfone) resin composed of the recurring units, which is shown below:

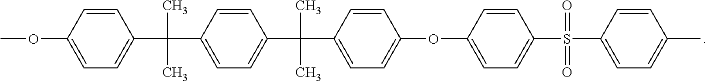

Said resin may be prepared by nucleophilic displacement of chlorine from 4,4′-dichlorodiphenyl sulfone (DCDPS) by a dialkali metal salt of alpha, alpha′-bis-(4-hydroxyphenyl)-p-diisopropylbenzene, as shown below:

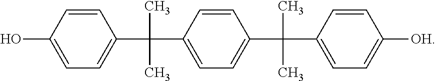 [SMILES: CC(C)(c1ccc(O)cc1)c1ccc(C(C)(C)c2ccc(O)cc2)cc1]

RADEL® (polyphenylsulfone (identified herein as PPSU) is another polysulfone available from Solvay Advanced Polymers, which is made by reacting units of 4,4′-dichlorodiphenyl sulfone (DCDPS) and 4,4′-biphenol (BP).

JP 07037524 discloses poly(arylethersulfone) copolymers comprising recurring units of following formula

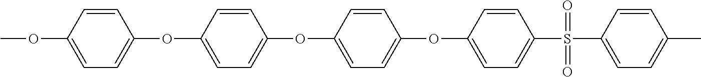

made by condensing 1,4-bis(4-hydroxyphenoxy) benzene and 4,4′-dichlorodiphenyl sulfone (DCDPS).

Keto group containing poly(arylethersulfone) polymers, made by polycondensation of 4,4′-dichlorodiphenyl sulfone (DCDPS) and keto group-containing bisphenols, in particular said bisphenols having formulas (I) and (II), as shown below, have been described in EP 0038028.

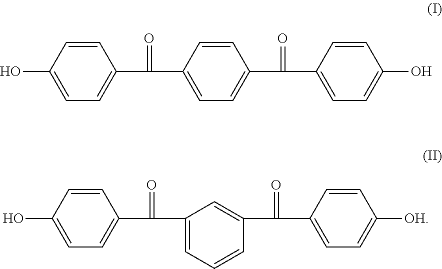 [SMILES: O=C(c1ccc(O)cc1)c1ccc(C(=O)c2ccc(O)cc2)cc1 ; O=C(c1ccc(O)cc1)c1cccc(C(=O)c2ccc(O)cc2)c1]

Other polysulfones include co-polymers having at least two different types of sulfone and/or diphenol groups. Veradel® polyethersulfones, available from Solvay Advanced Polymers, include a polyethersulfone portion made from repeating or recurring groups of formula —Ar—SO₂—Ar—O—, wherein Ar is a substituted or unsubstituted aryl group such as a phenyl, biphenyl, bisphenol or any other aryl group containing an aromatic or hetero-aromatic ring.

Nevertheless, for applications including those requiring contact with water, food, drugs and/or blood, it is important that polymeric materials are safe both for humans and environment. Polymeric materials in contact with food and drugs must meet certain requirements mandated by for instance the FDA, the European Food Safety Agency and the Environmental Protection Agency (EPA). It was mentioned that EPA would add BPA to its list of chemicals of concern, requiring environmental testing. But it should be noted that at this time the FDA is not proposing any regulations related to the requirements of BPA extracted from plastics.

There is thus a continuous need for new polymeric materials made from monomers (M) which have weak binding affinity for estrogen receptors and whereby said polymeric materials are particularly resistance to moisture, radiation, oxidization, and extreme temperatures, exhibit good mechanical properties, improved toughness and high strength.

### SUMMARY OF INVENTION

The Applicant has now found that certain polymeric materials can solve above mentioned problems and are particularly resistance to moisture, radiation, oxidization, and extreme temperatures, exhibit good mechanical properties, improved toughness and high strength. Therefore, they are very useful in the food and drugs industry, advantageously having a lower risk for human health. In particular, the new polymers comprising hydrophilic moieties exhibit reduced estrogenic activities.

It is thus an object of the present invention a polymer which comprises recurring units derived from at least one monomer (M) having a general formula (I)

Y₁—Z₁-Q-Z₂—Y₂ (I)

wherein
Y₁ and Y₂, equal or different from each other, are independently selected from a group consisting of OH, SH, Cl, Br, NO₂ or I;
Z₁ and Z₂, equal or different from each other, independently comprises at least 1 aromatic ring and,
Q comprises at least one hydrophilic moiety (H) selected from the group consisting of a sulfone (SO₂), a ketone (CO), a phosphine oxide (PO), an ether, a thioether, an ester, an anhydride, a carbonate, an amide, an imide, an imine and an urethane group, and
the interatomic distance between Y₁ and Y₂ is at least 10 Å, the monomer has an estrogen receptor binding affinity (K_{d}) value of equal to or at least 6 nM.

Another object of the present invention is a polymer which comprises recurring units derived from at least one monomer (M) having a general formula (I)

Y₁—Z₁-Q-Z₂—Y₂ (I)

wherein
Y₁ and Y₂, equal or different from each other, are independently selected from a group consisting of OH, SH, Cl, Br, NO₂ or I;
Z₁ and Z₂, equal or different from each other, independently comprises at least 1 aromatic ring and,
Q comprises at least one hydrophilic moiety (H) selected from the group consisting of a sulfone (SO₂), a ketone (CO), a phosphine oxide (PO), an ether, a thioether, an ester, an anhydride, a carbonate, an amide, an imide, an imine and an urethane group, and
the interatomic distance between Y₁ and Y₂ is at least 10 Å, the monomer has an EC₅₀ response value to the estrogen receptor α (ERα) equal to or at least 26000 nM.

For the purpose of the present invention, the interatomic distance between Y₁ and Y₂ has been theoretically measured by commercially available computational programs such as ACD/3D Viewer, version 5.0 for Microsoft Windows and CS Chem3D Pro, Molecular Modeling and Analysis, version 7.0. In general, all structures went through energy minimization using a molecular mechanical method which is built in both said software programs.

It is understood that if Y1 and Y2 comprise more than one atom which is the case for OH, SH and NO₂ then the interatomic distance is in general measured from the O, S or N atoms.

In one embodiment of the present invention, the interatomic distance between Y₁ and Y₂ is at least 10 Å, at least 11 Å, at least 12 Å, at least 13 Å, at least 14 Å, at least 15 Å, at least 16 Å, at least 17 Å, at least 18 Å, at least 19 Å, at least 20 Å, at least 21 Å, at least 22 Å, at least 23 Å, at least 24 Å, at least 25 Å, at least 26 Å, at least 27 Å, at least 28 Å, at least 29 Å, at least 30 Å, at least 31 Å, at least 32 Å, at least 33 Å, at least 34 Å, at least 35 Å.

In another embodiment of the present invention, the interatomic distance between Y₁ and Y₂ is in a range of from 10 Å to 18 Å; in a range from 11 Å to 17 Å, in a range from 12 Å to 16 Å, in a range from 13 Å to 15 Å.

In yet another embodiment of the present invention, the interatomic distance between Y₁ and Y₂ is in a range of from 18 Å to 26 Å; in a range from 19 Å to 25 Å, in a range from 20 Å to 24 Å, in a range from 21 Å to 23 Å.

In yet another embodiment of the present invention, the interatomic distance between Y₁ and Y₂ is in a range of from 26 Å to 35 Å; in a range from 29 Å to 34 Å, in a range from 30 Å to 33 Å, in a range from 31 Å to 33 Å.

For the purpose of the present invention, the term “estrogen receptor binding affinity (K_{d})” is intended to denote the equilibrium dissociation constant of the monomers (M) of the present invention with the estrogen receptor.

For the purpose of the present invention, the term “estrogen receptor” is intended to designate all the estrogen receptors including the estrogen receptors α and β (ERα and ERβ) and the estrogen related receptors α, β and γ (ERRα, ERRβ and ERRγ).

For the purpose of the present invention, the K_{d} value of the monomers (M) of formula (I) with the estrogen receptor is preferably determined by the competitive Scatchard method, as notably described in the articles: Ratajczak et al., Steroids, 1981, 38, pages 537-555; Lövgren T et al. J. Steroids Biochem., 1978, 9, pages 803-809; incorporated herein by reference in their entirety.

In one embodiment of the present invention, the K_{d} value of said monomer (M) of formula (I) is equal to or at least 6 nM, at least 7 nM, at least 8 nM, at least 9 nM, at least 10 nM, at least 11 nM, at least 12 nM, at least 13 nM, at least 14 nM, at least 15 nM, at least 16 nM, at least 17 nM, at least 18 nM, at least 19 nM, at least 20 nM, at least 100 nM, at least 1000 nM, at least 10000 nM.

In another embodiment of the present invention, the K_{d} value of said monomer (M) of formula (I) is in a range from 6 nM to 10000 nM, in a range from 6 nM to 1000 nM, in a range from 6 nM to 100 nM, in a range from 6 nM to 20 nM, in a range from 6 nM to 10 nM.

In another embodiment of the present invention, the K_{d} value of said monomer (M) of formula (I) is in a range from 6 nM to 20 nM, in a range from 6 nM to 15 nM, in a range from 6 nM to 10 nM.

For the purpose of the present invention, the response value “EC₅₀” is measured by using the GeneBLAzer® Cell-Based Nuclear Receptor Assay technology which is notably commercially provided by Invitrogen™ or Life Technologies™.

The GeneBLAzer® Cell-Based Nuclear Receptor Assay technology uses the GeneBLAzer® Betalactamase reporter technology, which is notably described in U.S. Pat. No. 5,955,604 incorporated herein by reference in its entirety.

Said GeneBLAzer® technology uses a mammalian-optimized Beta-lactamase reporter gene (bla) combined with a fluorescence resonant energy transfer (FRET)-enabled substrate to provide reliable and sensitive detection in intact cells. A non-limiting example of the FRET-enabled substrate is a CCF4 substrate.

The FRET-enabled substrate has coumarin and fluorescein moieties linked together via a beta-lactam ring.

The GeneBLAzer® technology is based on the transcription of Beta-lactamase. For example, GeneBLAzer®ER alpha DA (Division Arrested) cells and ER alpha-UAS-bla GripTite™ cells contain the ligand-binding domain (LBD) of the human Estrogen receptor α (ERα) fused to the DNA-binding domain of GAL4 stably integrated in the GeneBLAzer®UAS-bla GripTite™ cell line. GeneBLAzer®UAS-bla GripTite™ cells stably express a beta-lactamase reporter gene under the transcriptional control of an upstream activator sequence (UAS). When the momomers (M) of the present invention binds to the LBD of the GAL4 (DBD)-ER α (LBD) fusion protein, the protein binds to the UAS, resulting in expression of beta-lactamase.

Said cells are loaded with the FRET-enabled substrate, mentioned above. In the absence of beta-lactamase activity the unreacted FRET-enabled substrate molecule remains intact. Excitation of the coumarin by 409 nm light results in fluorescence resonant energy transfer (FRET) to the fluorescein moiety, which can be detected by green 530 nm fluorescence. In the presence of beta-lactamase expression, the FRET-enabled substrate molecule is cleaved at the beta-lactam ring, thereby separating the fluorophores and consequently the energy transfer is disrupted. Under these conditions, excitation of the coumarin results in the emission of blue 460 nm fluorescence.

Beta-lactamase expression is quantified by measuring the ratio of the blue product (460 nm) to the green substrate (530 nm) fluorescence.

In other words, the ratio of the blue 460 nm fluorescence emission to the green substrate (530 nm) fluorescence emission is a measure for the estrogenic activities of the momomers (M) of the present invention.

The EC₅₀ response value is typically derived from a set of measurements of said emission ratio according to the GeneBLAzer® Cell-Based Nuclear Receptor Assay technology. Said EC₅₀ response value typically represents the concentration of the monomers (M) of the present invention that gives half-maximal response in its binding to a genetically engineered protein with the binding region of ERα and a DNA binding region, as explained above. Therefore, the EC₅₀ response value typically expresses the estrogenic activity of the monomers (M) of the present invention. In other words, the higher the value of EC₅₀ (nM) of the monomers (M) of the present invention, the lower its estrogenic activity will be.

In one embodiment of the present invention, the EC₅₀ response value of said monomer (M) of formula (I) to the estrogen receptor α (ERα) is equal to or at least 30000 nM, at least 35000 nM, at least 70000 nM, at least 100000 nM, at least 150000 nM, at least 200000 nM, at least 250000 nM, at least 500000 nM, at least 1000000 nM.

In another embodiment of the present invention, the EC₅₀ response value of said monomer (M) of formula (I) to the estrogen receptor α (ERα) is in a range from 26000 nM to 1000000 nM, preferably in a range from 26000 nM to 500000 nM and more preferably in a range from 26000 nM to 250000 nM.

In a preferred embodiment of the invention, the monomer (M) has a general formula (II):

Y₁—Ar¹-Q-Ar²—Y₂ (II)

wherein Y1 and Y2 have the same meaning as above,
Ar¹, Ar² are equal or different from each other and are aromatic moieties preferably selected from the group consisting of those complying with following formulae:

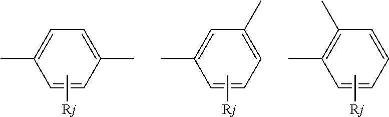

wherein R is selected from the group consisting of:
hydrogen, halogen, alkyl, alkenyl, alkynyl, aryl, ether, thioether, carboxylic acid, ester, amide, imide, alkali or alkaline earth metal sulfonate, alkyl sulfonate, alkali or alkaline earth metal phosphonate, alkyl phosphonate, amine and quaternary ammonium and j is 0, 1, 2, 3 or 4, and
Q comprises at least one group G_{H} comprising a hydrophilic moiety (H) selected from the group consisting of a sulfone (SO₂), a ketone (CO), a phosphine oxide (PO), an ether, a thioether, an ester, an anhydride, a carbonate, an amide, an imide, an imine and an urethane group.

The group G_{H} is preferably selected from the group consisting of those complying with formulae (G_{H}-1), (G_{H}-2), (G_{H}-3), (G_{H}-4), (G_{H}-5), (G_{H}-6), (G_{H}-7), (G_{H}-8) and (G_{H}-9):

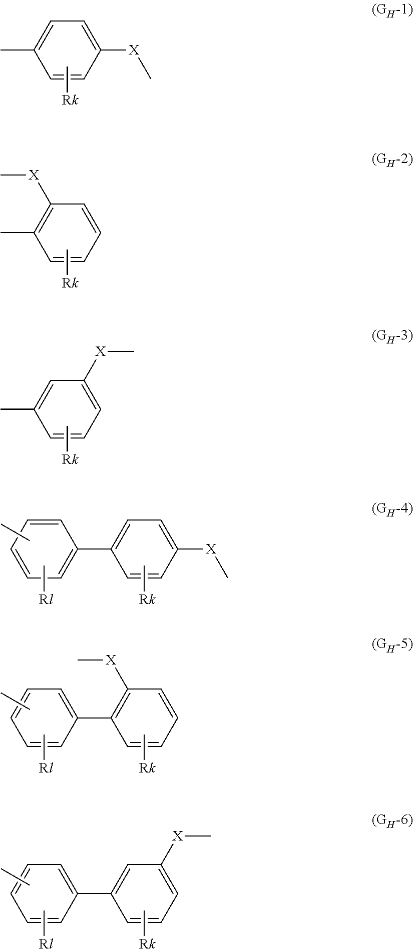

wherein each of R, equal or different from each other and at each occurrence, is independently selected from the group consisting of:
hydrogen, halogen, alkyl, alkenyl, alkynyl, aryl, ether, thioether, carboxylic acid, ester, amide, imide, alkali or alkaline earth metal sulfonate, alkyl sulfonate, alkali or alkaline earth metal phosphonate, alkyl phosphonate, amine and quaternary ammonium and k and 1 equal or different from each other, are independently 0, 1, 2, 3 or 4

—O—(CR₁R₂—CR₃R₄—O)—, (G_{H}-7)

in which R₁, R₂, R₃, and R₄ equal to or different from each other, are independently selected from H, an alkyl group having from 1 to 10 carbon atoms which is optionally substituted by at least one halogen atom, an aralkyl group or an aryl group;

—Ar³—X— (G_{H}-8)

wherein Ar³ is selected from the group consisting of fused benzenic rings such as naphthylenes (and in particular 2,6-naphthylene), anthrylenes (and in particular 2,6-anthrylene) and phenanthrylenes (and in particular 2,7-phenanthrylene), naphthacenylenes and pyrenylenes groups; an aromatic carbocyclic system comprising from 5 to 24 atoms, at least one of which is a heteroatom, such as pyridines, benzimidazoles, quinolines, etc. The hetero atom is often chosen from B, N, O, Si, P and S. It is more often chosen from N, O and S.

-A₁-X— (G_{H}-9)

wherein A1 is selected from the group consisting of a saturated carbocyclic system comprising 3 to 10 carbon atoms such as cyclohexyl and cycloheptyl; a saturated carbocyclic system comprising 3 to 10 carbon atoms, at least one of which is a heteroatom, such as pyrrolidine, piperidine, morpholine, perhydroquinoline, perhydroisoquinoline, tetrahydrofuran, tetrahydrothiophene, dioxane etc. The hetero atom is often chosen from B, N, O, Si, P and S. It is more often chosen from N, O and S
wherein X is selected from the group consisting of SO₂, C═O, —P═O, O, S, (C═O)O, (C═O)O(C═O), O(C═O)O, (C═O)NR₅, (C═O)NR₆(C═O), NR₇(C═NR₈)NR₉, and NR₁₀(C═O)O and wherein R₅, R₆, R₇, R₈, R₉ and R₁₀, equal or different from each other are selected from H, an alkyl group which is optionally substituted by at least one halogen atom, cycloalkyl group, heteroalkyl, an aralkyl group or an aryl group.

The term “alkyl group” is intended to denote in particular a linear or branched alkyl substituent comprising from 1 to 20 carbon atoms, preferably 1, 2, 3, 4, 5, 6, 7, 8, 9 or 10 carbon atoms. Specific examples of such substituents are methyl, ethyl, n-propyl, isopropyl, n-butyl, isobutyl, tert-butyl, n-pentyl, isopentyl, n-hexyl, 2-hexyl, n-heptyl, n-octyl and benzyl.

The term “cycloalkyl group” is intended to denote in particular a substituent comprising at least one saturated carbocycle containing 3 to 10 carbon atoms, preferably 5, 6 or 7 carbon atoms. Specific examples of such substituents are cyclopropyl, cyclobutyl, cyclopentyl, cyclohexyl and cycloheptyl.

The term “aryl group” is intended to denote in particular an aromatic ring group containing from 6 to 18 ring carbon atoms. Some particular illustrative examples of aryl radicals comprise substituted or unsubstituted phenyl, biphenyl, toluyl and naphthyl.

The term “aralkyl group” is intended to denote in particular an aromatic ring group substituted with alkyl groups such as tolyl, biphenylyl, etc.

In those formulae (H-1) to (H-6), R's are preferably independently selected from the group consisting of hydrogens and halogens, more preferably all R's are hydrogens.

In the molecule (II), R are preferably independently selected from the group consisting of hydrogens and halogens, more preferably all R's are hydrogens.

Non limitative examples of such monomers (M) containing a hydrophilic moiety (H) include:

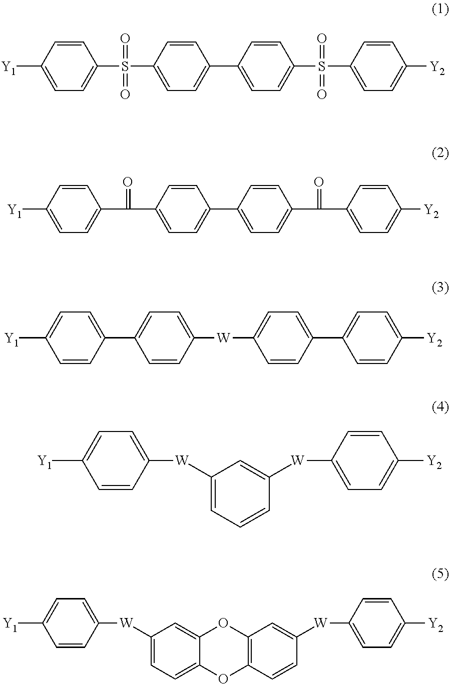

wherein W is O, CO, SO₂

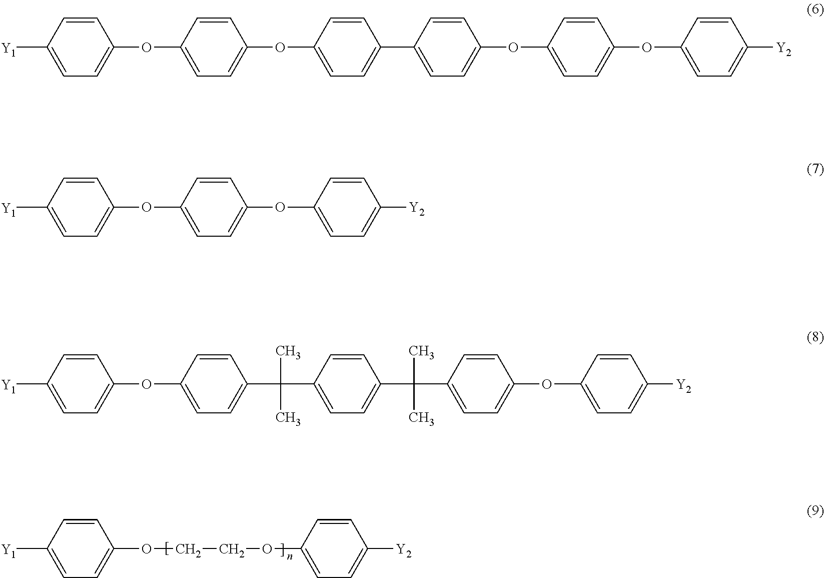

wherein n is 0, 1, 2, 3, 4, 5 or 6.

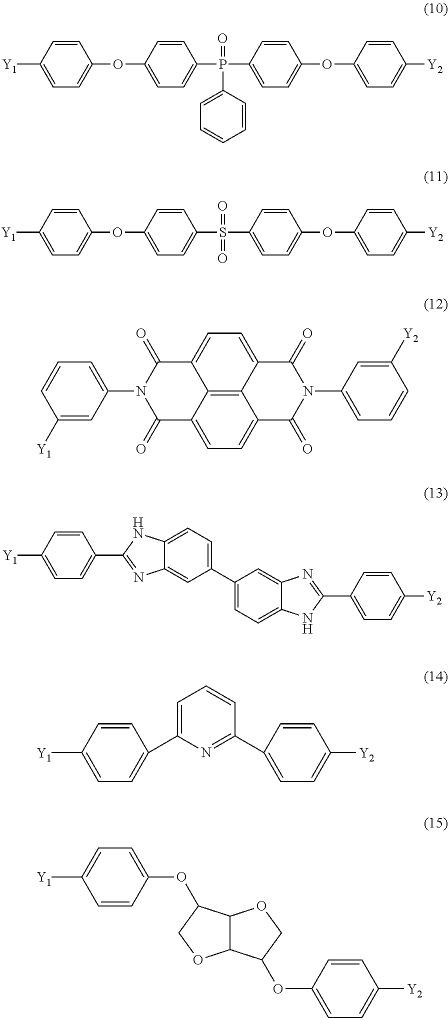

wherein Y₁ and Y₂, equal or different from each other, are independently selected from a group consisting of OH, SH, Cl, Br, NO₂, F or I.

In all the embodiments described above, Y₁ and Y₂, equal or different from each other, are preferably independently selected from a group consisting of OH and Cl.

The hydrophilic moiety (H) may be present in the polymer according to the present invention in its backbone or in its chain ends. They are preferably comprised in its recurring units.

In a first embodiment, the polymer of the present invention comprises recurring units (R1) obtainable by a self condensation reaction of at least one monomer (M-1), as detailed above, wherein Y₁ is OH and Y₂ is Cl or Y₁ is Cl and Y₂ is OH.

The polymer of the present invention comprises more than 10% wt, preferably more than 30% wt, of recurring units (R1).

In another aspect of this first embodiment, the polymer of the present invention consists essentially of recurring units (R1). End chains, defects and minor constituent can enter into the microstructure of said polymer without substantially modifying its properties.

In a second embodiment, the polymer of the present invention comprises recurring units (R2) obtainable by a polycondensation reaction of at least one monomer (M-1), as detailed above, wherein Y₁ is OH and Y₂ is Cl or Y₁ is Cl and Y₂ is OH and at least one aromatic monomer selected from a group consisting of an aromatic halohydroxy monomer; an aromatic dihalo monomer; an aromatic dihydroxy monomer; an aromatic dicarboxylic acid monomer; an aromatic hydroxycarboxylic acid monomer; another monomer (M-2), as detailed above, wherein Y₁ is OH and Y₂ is Cl or Y₁ is Cl and Y₂ is OH; a monomer (M-3), as detailed above, wherein Y₁ and Y₂ are OH and a monomer (M-4), as detailed above, wherein Y₁ and Y₂ are Cl; and a carbonate monomer.

The polymer of the present invention comprises more than 10% wt, preferably more than 30% wt, of recurring units (R2).

In another aspect of this second embodiment, the polymer of the present invention consists essentially of recurring units (R2). End chains, defects and minor constituent can enter into the microstructure of said polymer without substantially modifying its properties.

In a third embodiment, the polymer of the present invention comprises recurring units (R3) obtainable by a polycondensation reaction of at least one monomer (M-3), as detailed above, wherein Y₁ and Y₂ are OH and at least one aromatic monomer selected from a group consisting of an aromatic halohydroxy monomer; an aromatic dihalo monomer; an aromatic dicarboxylic acid monomer; an aromatic hydroxycarboxylic acid monomer; a monomer (M-1), as detailed above, wherein Y₁ is OH and Y₂ is Cl or Y₁ is Cl and Y₂ is OH; a monomer (M-4), as detailed above, wherein Y₁ and Y₂ are Cl; and a carbonate monomer.

The polymer of the present invention comprises more than 10% wt, preferably more than 30% wt, of recurring units (R3).

In another aspect of this third embodiment, the polymer of the present invention consists essentially of recurring units (R3). End chains, defects and minor constituent can enter into the microstructure of said polymer without substantially modifying its properties.

In a specific aspect of this third embodiment, the polymer of the present invention is a poly(arylethersulfone)polymer comprising recurring units derived from at least one aromatic dihalo compound comprising at least one —S(═O)₂— group and an aromatic diol (D) having general formula (III)

HO—Ar¹-Q-Ar²—OH (III)

wherein Ar¹, Ar² are equal or different from each other and are aromatic moieties of the formula:

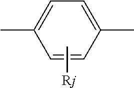

wherein R is selected from the group consisting of:
hydrogen, halogen, alkyl, alkenyl, alkynyl, aryl, ether, thioether, carboxylic acid, ester, amide, imide, alkali or alkaline earth metal sulfonate, alkyl sulfonate, alkali or alkaline earth metal phosphonate, alkyl phosphonate, amine and quaternary ammonium and j is 0, 1, 2, 3 or 4
wherein Q is a group chosen among the following structures (Q-1), (Q-2), (Q-3), (Q-4), (Q-5), (Q-6) and (Q-7):

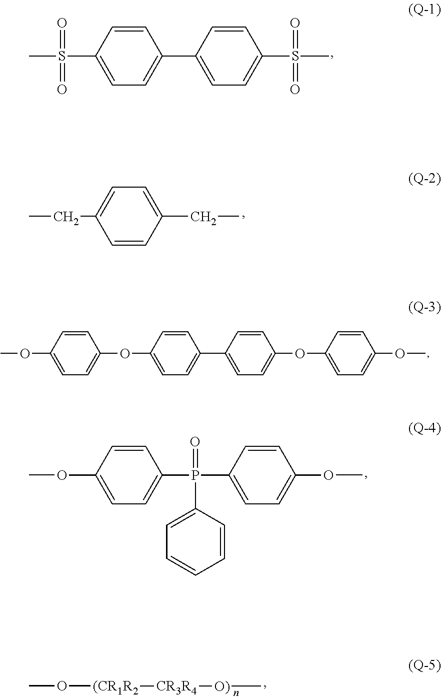

in which R₁, R₂, R₃, and R₄ equal to or different from each other, are independently selected from H, an alkyl group having from 1 to 10 carbon atoms which is optionally substituted by at least one halogen atom, an aralkyl group or an aryl group; n is 0, 1, 2, 3, 4, 5 or 6;

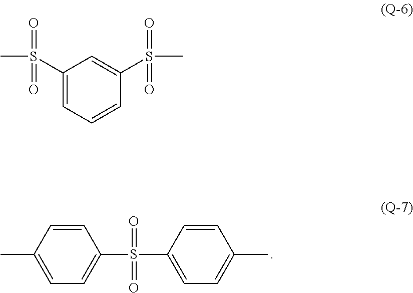

Preferably, R₁, R₂, R₃ and R₄ equal to or different from each other, are often independently selected from H, a C1-C4 alkyl group, optionally substituted by at least 1 halogen atom, an aryl group, for example, phenyl. More preferably, R₁, R₂, R₃ and R₄ equal to or different from each other, are independently from each other H, a linear or branched C1-C4 alkyl group optionally substituted by at least 1 halogen atom, and particularly preferably R₁, R₂, R₃ and R₄ are independently from each other H, methyl, ethyl, n-propyl or isopropyl each optionally substituted by at least 1 halogen atom. Most preferably, R₁, R₂, R₃ and R₄ are H.

In the molecule (III), R is preferably selected from the group consisting of hydrogens and halogens, more preferably R is hydrogen.

The poly(arylethersulfone)polymer comprises more than 10% wt, preferably more than 30% wt, of recurring units derived from at least one aromatic dihalocompound comprising at least one —S(═O)₂— group and the aromatic diol (D) having general formula (III), as detailed above.

In another embodiment of the present invention, the poly(arylethersulfone)polymer consists essentially of recurring units derived from at least one aromatic dihalocompound comprising at least one —S(═O)₂— group and the aromatic diol (D) having general formula (III), as detailed above. End chains, defects and minor constituent can enter into the microstructure of this poly(arylethersulfone)polymer without substantially modifying its properties.

In another specific aspect of this third embodiment, the polymer of the present invention is a polycarbonate polymer comprising recurring units derived from a carbonate compound selected from the groups consisting of a carbonyl halide, a carbonate ester and a halo formate; and an aromatic diol (D) having general formula (III)

HO—Ar¹-Q-Ar²—OH (III)

wherein Ar¹, Ar² are equal or different from each other and are aromatic moieties of the formula:

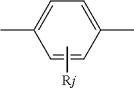

wherein R is selected from the group consisting of:
hydrogen, halogen, alkyl, alkenyl, alkynyl, aryl, ether, thioether, carboxylic acid, ester, amide, imide, alkali or alkaline earth metal sulfonate, alkyl sulfonate, alkali or alkaline earth metal phosphonate, alkyl phosphonate, amine and quaternary ammonium and j is 0, 1, 2, 3 or 4
wherein Q is a group chosen among the following structures (Q-1), (Q-2), (Q-3), (Q-4), (Q-5), (Q-6) and (Q-7):

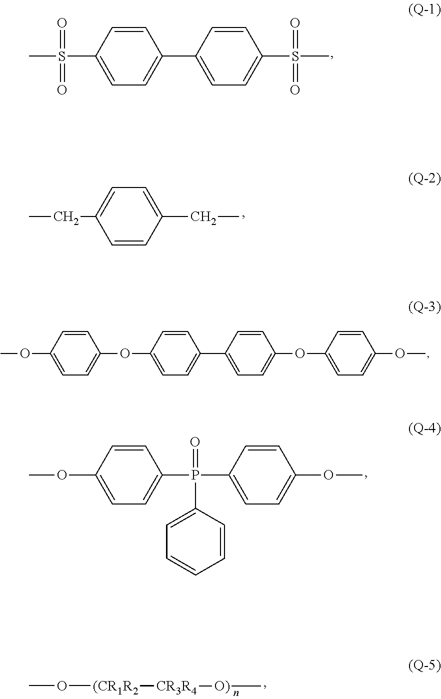

in which R₁, R₂, R₃, and R₄ equal to or different from each other, are independently selected from H, an alkyl group having from 1 to 10 carbon atoms which is optionally substituted by at least one halogen atom, an aralkyl group or an aryl group; n is 0, 1, 2, 3, 4, 5 or 6;

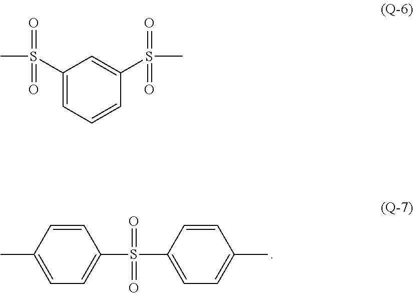

Preferably, R₁, R₂, R₃ and R₄ equal to or different from each other, are often independently selected from H, a C1-C4 alkyl group, optionally substituted by at least 1 halogen atom, an aryl group, for example, phenyl. More preferably, R₁, R₂, R₃ and R₄ equal to or different from each other, are independently from each other H, a linear or branched C1-C4 alkyl group optionally substituted by at least 1 halogen atom, and particularly preferably R₁, R₂, R₃ and R₄ are independently from each other H, methyl, ethyl, n-propyl or isopropyl each optionally substituted by at least 1 halogen atom. Most preferably, R₁, R₂, R₃ and R₄ are H.

In the molecule (III), R is preferably selected from the group consisting of hydrogens and halogens, more preferably R is hydrogen.

The polycarbonate polymer comprises more than 10% wt, preferably more than 30% wt, of recurring units derived from a carbonate compound selected from the groups consisting of a carbonyl halide, a carbonate ester and a haloformate; and the aromatic diol (D) having general formula (III), as detailed above.

In another embodiment of the present invention, the a polycarbonate polymer consists essentially of recurring units derived from a carbonate compound selected from the groups consisting of a carbonyl halide, a carbonate ester and a halo formate; and the aromatic diol (D) having general formula (III), as detailed above. End chains, defects and minor constituent can enter into the microstructure of this a polycarbonate polymer without substantially modifying its properties.

In a fourth embodiment, the polymer of the present invention comprises recurring units (R4) obtainable by a polycondensation reaction of at least one monomer (M-4), as detailed above, wherein Y₁ and Y₂ are Cl and at least one aromatic monomer selected from a group consisting of an aromatic halohydroxy monomer; an aromatic dihydroxy monomer; an aromatic hydroxycarboxylic acid monomer; a monomer (M-1), as detailed above, wherein Y₁ is OH and Y₂ is Cl or Y₁ is Cl and Y₂ is OH; a monomer (M-3), as detailed above, wherein Y₁ and Y₂ are OH.

The polymer of the present invention comprises more than 10% wt, preferably more than 30% wt, of recurring units (R4).

In another aspect of this fourth embodiment, the polymer of the present invention consists essentially of recurring units (R4). End chains, defects and minor constituent can enter into the microstructure of said polymer without substantially modifying its properties. The polycondensation reaction, as mentioned above, can be carried out according to known methods, i.e., a carbonate method; an alkali metal hydroxide method; or a phase transfer catalyzed method. The carbonate method is notably disclosed in U.S. Pat. Nos. CN 847,963; 6,593,445, U.S. Pat. Nos. 4,113,699; 4,176,222; U.S. Pat. No. 4,200,728 and U.S. Pat. No. 6,593,445 incorporated herein by reference in its entirety.

The alkali metal hydroxide method is notably described by Johnson et al., U.S. Pat. Nos. 4,108,837 and 4,175,175, incorporated herein by reference in its entirety.

The phase transfer catalyzed method is known in the prior art and as notably described in U.S. Pat. No. 5,239,043, can be conducted as notably set forth in U.S. Pat. Nos. 4,108,837 and 4,175,175, incorporated herein by reference in its entirety.

In one specific embodiment, the poly(arylethersulfone)polymer of the present invention are prepared by a polycondensation reaction which is carried out according to the carbonate method. Said carbonate method comprises contacting in a polycondensation reaction substantially equimolar amounts of the aromatic diol (D) of formula (III), as above detailed and at least one aromatic dihalocompound comprising at least one —S(═O)₂— group, as above detailed with an alkali metal carbonate in the presence of a solvent comprising a polar aprotic solvent.

General described, in the carbonate method, the process is conducted by contacting substantially equimolar amounts of an aromatic bishydroxy monomer, e.g. the aromatic diol (D) of formula (III) of the present invention and at least one dihalodiarylsulfones, e.g., 4,4′-dichlorodiphenyl sulfone or 4,4′-difluorodiphenyl sulfone, with from about 0.5 to about 1.1 mole, preferably from about 1.01 to about 1.1 mole, more preferably from about 1.05 to about 1.1 mole of an alkali metal carbonate per mole of hydroxyl group.

The alkali metal carbonate is preferably sodium carbonate, potassium carbonate, rubidium carbonate and cesium carbonate. Sodium carbonate and potassium carbonate are especially preferred. Mixtures of more than one carbonates can be used, for example, a mixture of sodium carbonate or bicarbonate and a second alkali metal carbonate or bicarbonate having a higher atomic number than that of sodium, as notably described in U.S. Pat. No. 4,176,222.

The use of an alkali metal carbonate having an average particle size of less than about 100 μm is particularly preferred. More preferably, an alkali metal carbonate average particle size of less than about 50 μm is used. Still more preferably, an alkali metal carbonate average particle size of less than about 30 μm is used. The use of an alkali metal carbonate having such a particle size permits the synthesis of the polymers to be carried out at a relatively lower reaction temperature with faster reaction. Similar methods are notably disclosed in U.S. Pat. No. 6,593,445, incorporated herein by reference in its entirety. Sodium and potassium carbonate salts, singly or in combination, may be used to provide polymers having desirable molecular weight characteristics. Higher molecular weight polymers may be obtained when a potassium salt is used.

The components are dissolved or dispersed in a solvent mixture comprising a polar aprotic solvent. If desired, an additional solvent can be used together with the polar aprotic solvent which forms an azeotrope with water, whereby water formed as a byproduct during the polymerization may be removed by azeotropic distillation continuously throughout the polymerization. In general, the reaction medium is maintained in substantially anhydrous conditions during the polymerization by removing water continuously from the reaction mass. Water can be removed by distillation or with the azeotrope-forming solvent as an azeotrope, as described above.

For the purpose of the present invention, the term “additional solvent” is understood to denote a solvent different from the reactants and the products of said reaction.

The polar aprotic solvents employed are those generally known in the art and widely used for the manufacture of poly (aryl ether sulfones). For example, the sulfur containing solvents known and generically described in the art as dialkyl sulfoxides and dialkylsulfones wherein the alkyl groups may contain from 1 to 8 carbon atoms, including cyclic alkyliden analogs thereof, are disclosed in the art for use in the manufacture of poly (aryl ether sulfones). Specifically, among the sulfur-containing solvents that may be suitable for the purposes of this invention are dimethylsulfoxide, dimethylsulfone, diphenylsulfone, diethylsulfoxide, diethylsulfone, diisopropylsulfone, tetrahydrothiophene-1,1-dioxide (commonly called tetramethylene sulfone or sulfolane) and tetrahydrothiophene-1-monoxide and mixtures thereof. Nitrogen-containing polar aprotic solvents, including dimethylacetamide, dimethylformamide and N-methyl pyrrolidinone (i.e., NMP) and the like have been disclosed in the art for use in these processes, and may also be found useful in the practice of this invention.

The additional solvent that forms an azeotrope with water will generally be selected to be inert with respect to the monomer components and polar aprotic solvent. Suitable azeotrope-forming solvents for use in such polymerization processes include aromatic hydrocarbons such as benzene, toluene, xylene, ethylbenzene, chlorobenzene and the like.

The azeotrope-forming solvent and polar aprotic solvent are typically employed in a weight ratio of from about 1:10 to about 1:1, preferably from about 1:5 to about 1:3.

Generally, after an initial heat up period, the temperature of the reaction mixture will be maintained in a range of advantageously from 80-240° C., preferably from 150 to 230° C., more preferably from 190 to 230° C., most preferable from 200 to 225° C. for about 0.5 to 3 hours.

Typically, if the reaction is conducted at atmospheric pressure, the boiling temperature of the solvent selected usually limits the temperature of the reaction. The reaction may be conveniently carried out in an inert atmosphere, e.g., nitrogen, at atmospheric pressure, although higher or lower pressures may also be used. It is generally preferred that the reaction medium be maintained substantially anhydrous during the polycondensation. While amounts of water up to about one percent, preferably no more than 0.5 percent by weight, can be tolerated, and are somewhat beneficial when employed with fluorinated dihalobenzenoid compounds, amounts of water substantially greater than this are desirably avoided as the reaction of water with the halo compound leads to formation of phenolic species and consequently low molecular weight products are obtained.

Preferably, after the desired molecular weight has been attained, the polymer is treated with an activated aromatic halide or an aliphatic halide such as methyl chloride or benzyl chloride, and the like. Such treatment of the polymer converts the terminal hydroxyl groups into ether groups which stabilize the polymer. The polymer so treated has good melt and oxidative stability.

In another specific embodiment, the poly(arylethersulfone)polymer of the present invention are prepared by a polycondensation reaction which is carried out according to the alkali metal hydroxide method. While the carbonate method for preparing the polymer of this invention is simple and convenient, in some cases products of higher molecular weight can be made by said alkali metal hydroxide method. In the alkali metal hydroxide method, as notably described by Johnson et al., U.S. Pat. Nos. 4,108,837 and 4,175,175, a double alkali metal salt of a dihydric phenol is contacted with a dihalobenzenoid compound in the presence of a polar aprotic solvent, e.g. a sulfur containing solvent such as dimethylsulfoxide, dimethylsulfone, diphenylsulfone, diethylsulfoxide, diethylsulfone, diisopropylsulfone, tetrahydrothiophene-1,1-dioxide (commonly called tetramethylene sulfone or sulfo lane) and tetrahydrothiophene-1-monoxide and mixtures thereof under substantially anhydrous conditions.

In yet another specific embodiment, the poly(arylethersulfone)polymer of the present invention are prepared by a polycondensation reaction which is carried out according to the phase transfer catalyzed method. While the carbonate method and the alkali metal hydroxide method are normally conducted in the presence of polar aprotic solvents, the phase transfer catalyzed method can be carried out in non-polar solvents due to the employment of a phase transfer catalyst, facilitating incorporation of the salt of an aromatic bishydroxy monomer, (e.g. the aromatic diol (D) of formula (III)) in the organic phase.

Many types of phase transfer catalysts are known, including quaternary ammonium and phosphonium salts as notably disclosed in U.S. Pat. No. 4,273,712; various bis-quaternary ammonium or phosphonium salts as notably disclosed in U.S. Pat. No. 4,554,357; aminopyridinium salts as notably disclosed in U.S. Pat. No. 4,460,778; alkoxylated tertiary amine compounds as notably disclosed in U.S. Pat. No. 5,235,020 or macro bicyclic compounds are notably disclosed in U.S. Pat. Nos. 3,966,766 and 4,156,683.

The phase transfer catalyzed method is known in the prior art and as notably described in U.S. Pat. No. 5,239,043, can be conducted as notably set forth in U.S. Pat. Nos. 4,108,837 and 4,175,175, i.e., by a substantially equimolar reaction of a double alkali metal salt of a dihydric phenol with a dihalobenzenoid compound, except that the presence of liquid organic sulfone or sulfoxide solvents and cosolvents under substantially anhydrous conditions are not required and phase transfer catalysts are used for this reaction.

The poly(arylethersulfone) can be recovered by methods well known and widely employed in the art such as, for example, coagulation, solvent evaporation and the like.

The resulting poly(arylethersulfone) polymer may be isolated by devolatilization of the reaction mixture after separation of salts with or without first adding additional solvent such as sulfolane or a mixture of sulfolane with another solvent, optionally the azeotrope solvent, to fully dissolve any polymer and cause the precipitation of the metal halide. Alternatively, the polymer may be isolated by precipitation and/or coagulation by contacting the reaction mixture with a non-solvent for the polymer such as an alcohol or water, or mixtures thereof. The precipitate/coagulate may be rinsed and/or washed with demineralized water prior to drying under reduced pressure and elevated temperature. The resulting precipitate may be further processed by extruding and pelletizing. The pelletized product may subsequently be subjected to further melt processing such as injection moulding and/or sheet extrusion. The conditions for moulding, extruding, and thermoforming the resulting poly(arylethersulfone) are well known in the art.

In yet another specific embodiment, the polycarbonate polymers of the present invention can be prepared by methods known in the prior art and as notably described in U.S. Pat. Nos. 4,123,436.

In a fifth embodiment, the polymer of the present invention comprises recurring units (R5) obtainable by a self reductive coupling reaction of at least one monomer (M-4), as detailed above, wherein Y₁ and Y₂ are Cl.

The polymer of the present invention comprises more than 10% wt, preferably more than 30% wt, of recurring units (R5).

In another aspect of this fifth embodiment, the polymer of the present invention consists essentially of recurring units (R5). End chains, defects and minor constituent can enter into the microstructure of said polymer without substantially modifying its properties.

In a sixth embodiment, the polymer of the present invention comprises recurring units (R6) obtainable by a reductive coupling reaction of at least one monomer (M-4), as detailed above, wherein Y₁ and Y₂ are Cl and at least one aromatic monomer selected from a group consisting of an aromatic dihalo monomer and another monomer (M-5), as detailed above, wherein Y₁ and Y₂ are Cl.

The polymer of the present invention comprises more than 10% wt, preferably more than 30% wt, of recurring units (R6).

In another aspect of this sixth embodiment, the polymer of the present invention consists essentially of recurring units (R6). End chains, defects and minor constituent can enter into the microstructure of said polymer without substantially modifying its properties.

The reductive coupling reaction is notably disclosed in U.S. Pat. No. 7,365,146 and U.S. Pat. No. 4,263,466, incorporated herein by reference in its entirety.

For the purpose of the present invention, an aromatic halohydroxy monomer is intended to denote any aromatic halohydroxy monomers suitable to polymerize with the monomers (M-1), (M-3) and (M-4).

Unlimited examples of aromatic halohydroxy monomers suitable to polymerize with the monomers (M-1), (M-3) and (M-4) are 4-chloro-4′-hydroxydiphenyl sulfone, 4-fluoro, 4′-hydroxydiphenyl sulfone, 4-bromo, 4′-hydroxydiphenyl sulfone and 4-hydroxy, 4′-iododiphenyl sulfone, chlorohydroxydiphenyl ether, chlorohydroxydiphenyl methylene, chlorohydroxydiphenyl biphenyl, p-chlorohydroxybenzene, 4-chloro-4′-hydroxybiphenyl, 2-chloro, 5-hydroxybenzophenone, 5-chloro, 2-hydroxybenzophenone, 4-chloro-4′-hydroxybenzophenone, 2-fluoro, 5-hydroxybenzophenone, fluoro-chloro, 2-hydroxybenzophenone, 4-fluoro-4′-hydroxybenzophenone.

For the purpose of the present invention, an aromatic dihalo monomers is intended to denote any aromatic dihalo monomers suitable to polymerize with the monomers (M-1) and (M-3) and (M-4).

Unlimited examples of aromatic dihalo monomers suitable to polymerize with the monomers (M-1) and (M-3) and (M-4) are 4,4′-dichlorodiphenyl sulfone, 4,4′-difluorodiphenyl sulfone, 4,4′-dibromodiphenyl sulfone, 4,4′-diiododiphenyl sulfone, 4,4′-bis[(4-chlorophenyl)sulfonyl]-1,1′-biphenyl, dichlorodiphenyl ketone, dichlorodiphenyl ether, dichlorodiphenyl methylene, dichlorodiphenyl biphenyl, p-dichlorobenzene, p-dichlorobiphenyl, 2,5-dichlorobenzophenone, 2,5-dichloro-4′-phenoxybenzophenone (p-dichlorobenzophenone), 4,4′-difluorobenzophenone, 4,4′-dichlorobenzophenone, 4-chloro-4′-fluorobenzophenone.

For the purpose of the present invention, any aromatic dihalocompound comprising at least one —S(═O)₂— group which is able to polymerize with the aromatic diol (D) is suitable.

Unlimited examples of aromatic dihalocompounds suitable to the purpose of the present invention are compounds of general formula (IV):

X—[Ar³—SO₂—Ar⁴]—[Ar⁵]ₙ—[Ar³—SO₂—Ar⁴]ₘ—X (IV)

wherein n and m are independently 0, 1, 2, 3 or 4;
wherein X is an halogen selected from chlorine, fluorine, bromine and iodine; wherein Ar³, Ar⁴ are equal or different from each other and are aromatic moieties of the formula:

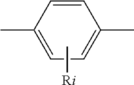

wherein Ar⁵ is selected from the group consisting of:

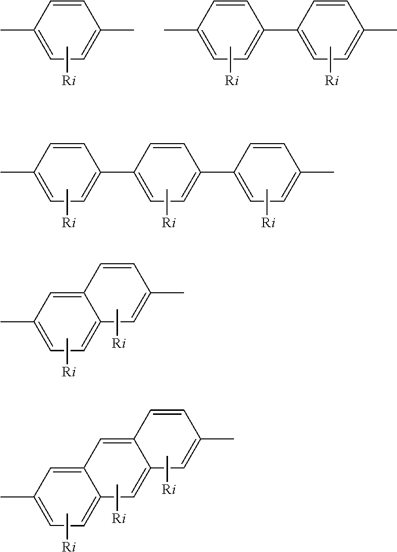

wherein R are independently selected from the group consisting of:
hydrogen, halogen, alkyl, alkenyl, alkynyl, aryl, ether, thioether, carboxylic acid, ester, amide, imide, alkali or alkaline earth metal sulfonate, alkyl sulfonate, alkali or alkaline earth metal phosphonate, alkyl phosphonate, amine and quaternary ammonium and i is 0, 1, 2, 3, or 4.

In the molecule (IV), n and m are preferably independently 0, 1 or 2, more preferably n and m are 0 or 1. Also, X is preferably selected from F and Cl. In addition, R are preferably independently selected from the group consisting of hydrogens and halogens, more preferably all R's are hydrogens.

According to the present invention, the above mentioned “molecule (IV)” may notably be one of the following molecules:

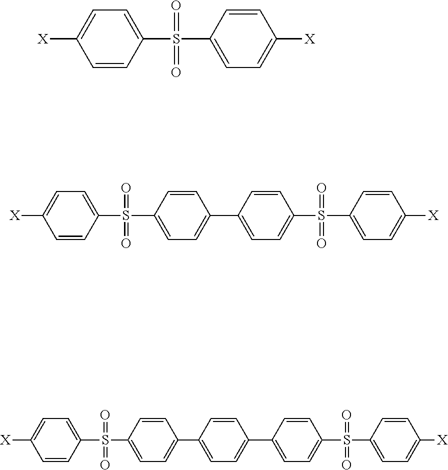

where X may be the same or different and are any halogen atoms chosen from chlorine, fluorine, bromine and iodine. The above structure may also be substituted by groups similar to the Ri described above.

In other words, the molecule (IV) may be a dihalodiphenyl sulfone such as 4,4′-dichlorodiphenyl sulfone, 4,4′-difluorodiphenyl sulfone, 4,4′-dibromodiphenyl sulfone and 4,4′-diiododiphenyl sulfone or mixed derivatives. Most preferred aromatic dihalocompounds are 4,4′-dichlorodiphenyl sulfone and 4,4′-difluorodiphenyl sulfone.

For the purpose of the present invention, an aromatic dihydroxy monomers is intended to denote any aromatic dihydroxy monomers suitable to polymerize with the monomers (M-1) and (M-4).

Unlimited examples of aromatic dihydroxy monomers suitable to polymerize with the monomers (M-1) and (M-4) are 4,4′-biphenol, hydroquinone, resorcinol, 3,3′-biphenol, 2,4′-biphenol, 2,3′-biphenol, and 3,4′-biphenol, 2,6 dihydroxynaphthalene, 2,7-dihydroxynaphthalene, 1,6-dihydroxynaphthalene, 1,4-dihydroxynaphthalene, 4,4′-(cyclopentylidene)diphenol; 4,4′-(3,3,5-trimethylcyclopentylidene)diphenol; 4,4′-(cyclohexylidene)diphenol; 4,4′-(3,3-dimethylcyclohexylidene)diphenol; 4,4′-(3,3,5-trimethylcyclohexylidene)diphenol; 4,4′-(methylcyclohexylidene)diphenol; 4,4′-bis(3,5-dimethyl)diphenol, 1,1-bis(4-hydroxy-3-methylphenyl)cyclohexane; 4,4-bis(4-hydroxyphenyl)heptane; 2,4′-dihydroxydiphenylmethane; bis(2-hydroxyphenyl)methane; bis(4-hydroxyphenyl)methane; bis(4-hydroxy-5-nitrophenyl)methane; bis(4-hydroxy-2,6-dimethyl-3-methoxyphenyl)methane; 1,1-bis(4-hydroxyphenyl)ethane; 1,2-bis(4-hydroxyphenyl)ethane; 1,1-bis(4-hydroxy-2-chlorophenyl)ethane; 2,2-bis(4-hydroxyphenyl)propane (commonly known as bisphenol A); 2,2-bis(3-phenyl-4-hydroxyphenyl)propane; 2,2-bis(4-hydroxy-3-methylphenyl)propane; 2,2-bis(4-hydroxy-3-ethylphenyl)propane; 2,2-bis(4-hydroxy-3-isopropylphenyl)propane; 2,2-bis(4-hydroxy-3,5-dimethylphenyl)propane; 3,5,3′,5′-tetrachloro-4,4′-dihydroxyphenyl)propane; bis(4-hydroxyphenyl)cyclohexylmethane; 2,2-bis(4-hydroxyphenyl)-1-phenylpropane; 2,4′-dihydroxyphenyl sulfone; dihydroxy naphthalene, 2,6-dihydroxy naphthalene; C1-3 alkyl-substituted resorcinols; 2,2-bis-4-hydroxyphenyl)butane; 2,2-bis-(4-hydroxyphenyl)-2-methylbutane; 1,1-bis-(4-hydroxyphenyl)cyclohexane; bis-(4-hydroxyphenyl); bis-(4-hydroxyphenyl)sulphide; 2-(3-methyl-4-hydroxyphenyl-2-(4-hydroxyphenyl)propane; 2-(3,5-dimethyl-4-hydroxyphenyl)-2-(4-hydroxyphenyl)propane; 2-(3-methyl 4-hydroxyphenyl)-2-3,5-dimethyl-4-hydroxyphenyl)propane; bis-(3,5-dimethylphenyl-4-hydroxyphenyl)methane; 1,1-bis-(3,5-dimethylphenyl-4-hydroxyphenyl)ethane; 2,2-bis-(3,5-dimethylphenyl-4-hydroxyphenyl)propane; 2,4-bis-(3,5-dimethylphenyl-4-hydroxyphenyl)-2-methylbutane; 3,3-bis-(3,5-dimethylphenyl-4-hydroxyphenyl)pentane; 1,1-bis-(3,5-dimethylphenyl-4-hydroxyphenyl)cyclopentane; 1,1-bis-(3,54-dimethylphenyl-4-hydroxyphenyl)cyclohexane, bis-(3,5-dimethylphenyl-4-hydroxyphenyl)sulphide, 3-(4-hydroxyphenyl)-1,1,3-trimethylindan-5-ol, and 1-(4-hydroxyphenyl)-1,3,3-trimethylindan-5-ol. and alkyl, aryl, alkoxy, aryloxy or halogen substituted derivatives thereof.

A preferred aromatic diol (D) of the poly(arylethersulfone)polymer having a (Q-1) type structure is according to formula (D-1):

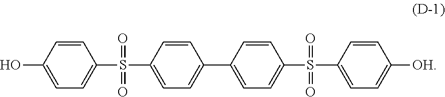 [SMILES: O=S(=O)(c1ccc(O)cc1)c1ccc(-c2ccc(S(=O)(=O)c3ccc(O)cc3)cc2)cc1]

A preferred aromatic diol (D) of the poly(arylethersulfone)polymer having a (Q-2) type structure is according to formula (D-2):

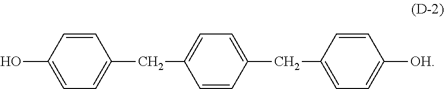 [SMILES: Oc1ccc(Cc2ccc(Cc3ccc(O)cc3)cc2)cc1]

A preferred aromatic diol (D) of the poly(arylethersulfone)polymer having a (Q-3) type structure is according to formula (D-3):

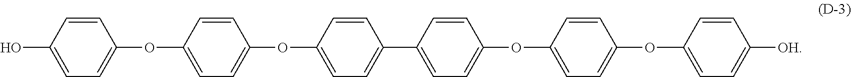 [SMILES: Oc1ccc(Oc2ccc(Oc3ccc(-c4ccc(Oc5ccc(Oc6ccc(O)cc6)cc5)cc4)cc3)cc2)cc1]

A preferred aromatic diol (D) of the poly(arylethersulfone)polymer having a (Q-4) type structure is according to formula (D-4):

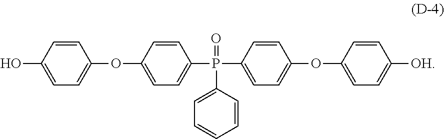 [SMILES: O=P(c1ccccc1)(c1ccc(Oc2ccc(O)cc2)cc1)c1ccc(Oc2ccc(O)cc2)cc1]

A preferred aromatic diol (D) of the poly(arylethersulfone)polymer having a (Q-5) type structure is according to formula (D-5):

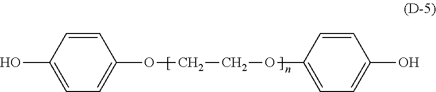

wherein n has the same meaning as above defined;

A preferred aromatic diol (D) of the poly(arylethersulfone)polymer having a (Q-6) type structure is according to formula (D-6):

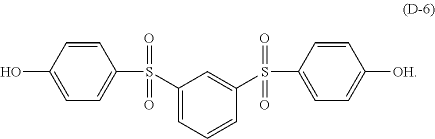 [SMILES: O=S(=O)(c1ccc(O)cc1)c1cccc(S(=O)(=O)c2ccc(O)cc2)c1]

A preferred aromatic diol (D) of the poly(arylethersulfone)polymer having a (Q-6) type structure is according to formula (D-7):

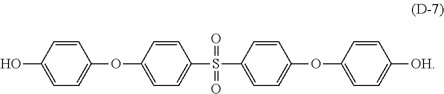 [SMILES: O=S(=O)(c1ccc(Oc2ccc(O)cc2)cc1)c1ccc(Oc2ccc(O)cc2)cc1]

In another embodiment of the present invention, the poly(arylethersulfone)polymer within the different embodiments can further comprise recurring units derived from an aromatic diol (D1), which is different from the aromatic diol (D). Any aromatic diol which is able to polymerize with the aromatic dihalocompound (IV) is suitable to be used as aromatic diol (D1). Non limitative examples of such aromatic diols (D1) are 4,4′-biphenol (i.e. 4,4′-dihydroxybiphenyl), bisphenol A, 4,4′-dihydroxy-diphenylsulfone (also known as bisphenol S), hydroquinone, 4,4′-dihydroxy-diphenylether, alpha, alpha′-bis-(4-hydroxyphenyl)-p-diisopropylbenzene, 1,4-bis(4-hydroxyphenoxy)benzene.

A poly(arylethersulfone)polymer comprising recurring units derived from a 4,4′-dihalodiphenylsulfone (especially 4,4′-dichlorodiphenylsulfone) and an aromatic diol (D) selected from the group consisting of those complying with formulae (D-1), (D-2), (D-3), (D-4), (D-5), (D-6) and (D-7), as detailed above, is especially preferred.

A poly(arylethersulfone)polymer comprising recurring units derived from a 4,4′-dihalodiphenylsulfone (especially 4,4′-dichlorodiphenylsulfone) and an aromatic diol (D) complying with formulae (D-6), as detailed above, is most preferred.

The invention further pertains to an aromatic diol (D) having general formula (III)

HO—Ar¹-Q-Ar²—OH (III)

wherein Ar¹, Ar² are equal or different from each other and are aromatic moieties of the formula:

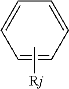

wherein R is selected from the group consisting of:
hydrogen, halogen, alkyl, alkenyl, alkynyl, aryl, ether, thioether, carboxylic acid, ester, amide, imide, alkali or alkaline earth metal sulfonate, alkyl sulfonate, alkali or alkaline earth metal phosphonate, alkyl phosphonate, amine and quaternary ammonium and j is 0, 1, 2, 3 or 4.
wherein Q is a group chosen among the following structures (Q-1), (Q-2), (Q-3), (Q-4), (Q-5), (Q-6) and (Q-7):

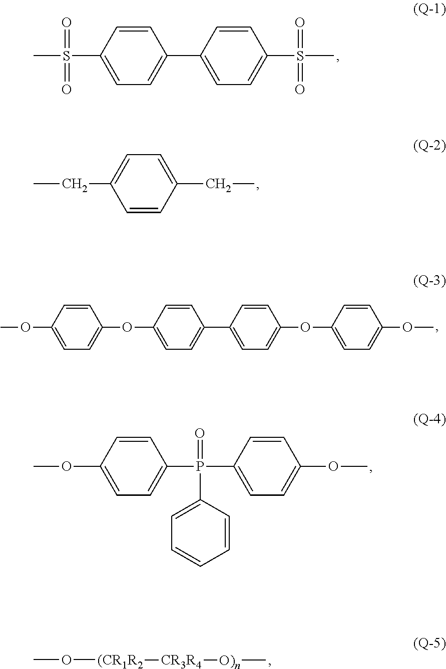

in which R₁, R₂, R₃, and R₄ equal to or different from each other, are independently selected from H, an alkyl group having from 1 to 10 carbon atoms which is optionally substituted by at least one halogen atom, an aralkyl group or an aryl group; n is 0, 1, 2, 3, 4, 5 or 6;

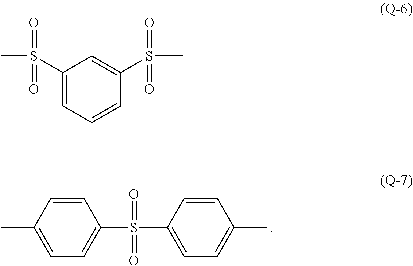

In the molecule (III), R is preferably selected from the group consisting of hydrogens and halogens, more preferably all R are hydrogen.

Preferred aromatic diols (D) of the invention are those of formulae (D-3) and (D-6) as detailed above.

For the purpose of the present invention, an aromatic dicarboxylic acid monomers is intended to denote any aromatic dicarboxylic acid monomer which is able to polymerize with the monomers (M-1) and (M-3).

Unlimited examples of any aromatic dicarboxylic acid monomer which is able to polymerize with the monomers (M-1) and (M-3) are terephthalic acid, isophthalic acid, 2,6-naphthalic dicarboxylic acid, 3,6-naphthalic dicarboxylic acid, 1,5-naphthalic dicarboxylic acid, 2,5-naphthalic dicarboxylic acid, 2,7-naphthalic dicarboxylic acid, 1,4-naphthalic dicarboxylic acid, 4,4′-dicarboxybiphenyl, and alkyl, aryl, alkoxy, aryloxy or halogen substituted derivatives thereof.

For the purpose of the present invention, an aromatic hydroxycarboxylic monomers is intended to denote any hydroxycarboxylic acid monomer which is able to polymerize with the monomers (M-1), (M-3) and (M-4).

Unlimited examples of any hydroxycarboxylic acid monomer which is able to polymerize with the monomers (M-1), (M-3) and (M-4) are p-hydroxybenzoic acid, 5-hydroxyisophthalic acid, m-hydroxybenzoic acid, o-hydroxybenzoic acid, 4′ hydroxyphenyl-4-benzoic acid, 3′-hydroxyphenyl-4-benzoic acid, 4′ hydroxyphenyl-3-benzoic acid, 2,6-hydroxynaphthalic acid, 3,6-hydroxynaphthalic acid, 3,2-hydroxynaphthalic acid, 1,6-hydroxynaphthalic acid, and 2,5-hydroxynaphthalic acid, and alkyl, aryl, alkoxy, aryloxy or halogen substituted derivatives thereof.

For the purpose of the present invention, a carbonate monomer is intended to denote any carbonate monomer which is able to polymerize with the monomers (M-1) and (M-3).

The carbonate monomer may be either a carbonyl halide, a carbonate ester or a haloformate. The carbonyl halides which can be employed herein are carbonyl bromide, carbonyl chloride, also known as phosgene, and mixtures thereof. Unlimited examples of carbonate esters which may be employed herein are notably diphenyl carbonate, di-(halophenyl) carbonates such as di-(chlorophenyl) carbonate, di-(bromophenyl) carbonate, di-(trichlorophenyl) carbonate, di-(tribromophenyl) carbonate, etc., di-(alkylphenyl) carbonates such as di(tolyl) carbonate, etc., di-(naphthyl) carbonate, di-(chloronaphthyl) carbonate, phenyl tolyl carbonate, chlorophenyl chloronaphthyl carbonate, etc., or mixtures thereof. Suitable haloformates include notably bis-haloformates of dihydric phenols (bischloroformates of hydroquinone, etc.) or glycols (bishaloformates of ethylene glycol, neopentyl glycol, polyethylene glycol, etc.).

Non limitative examples of polymers made from monomers (M) that may be according to the present invention are: poly(arylethersulfone)s such as poly(biphenyl ether sulfone), a polyphenylsulfone, poly(aryletherketone)s such poly(etheretherketone)s, polyarylene polymers such as poly(phenylene)s, poly(naphthylene)s, poly(anthrylene)s, poly(phenanthrylene)s, poly(tetracenylene)s, poly(triphenylylene)s, poly(pyrenylene)s, and perylenylenes, polyesters, polycarbonates, polyamides, polyimides, epoxy resins.

The polymer of the present invention has a number average molecular weight of advantageously at least 500, preferably at least 5,000 and more preferably at least 10,000. In addition, the polymer of the present invention has a number average molecular weight of advantageously at most 40,000, preferably at most 35,000, and more preferably at most 30,000.

The present invention also concerns polymer compositions that include at least one of the invented polymers, and at least one other ingredient. Said optional ingredient can notably be a polymer of the same type or another polymer such as polyvinylpyrrolidone and polyethylene glycol. It can also be a non polymeric ingredient such as a solvent, a filler, a lubricant, a mould release, an antistatic agent, a flame retardant, an anti-fogging agent, a matting agent, a pigment, a dye and an optical brightener.

An example of such polymer composition is a dope solution suitable for the preparation of membranes.

The polymer present in the composition according to the present invention has the same characteristics as the polymer according to the present invention, in all its embodiments, as above detailed.

The polymer composition comprise advantageously more than 1 wt. %, preferably more than 10 wt. %, still more preferably more than 50 wt. %, and the most preferably more than 90 wt. %, related to the total weight of the composition, of the polymer.

The polymer or the polymer composition of the present invention can then be fabricated, e.g. by moulding (injection moulding, extrusion moulding), calendering, or extrusion, into a desired shaped article.

In a preferred embodiment of the present invention, the polymer or the polymer composition of the present invention is used for fabrication of membranes, in particular, isotropic and anisotropic porous hollow fiber and flat sheet membranes for the entire range of the filtration spectrum from microfiltration, ultrafiltration to reverse osmosis (RO).

The membranes according to the present invention can be manufactured using any of the conventionally known membrane preparation methods, for example, by a solution casting or solution spinning method.

In a specific aspect of this embodiment, the polymer present in the composition is a poly(arylethersulfone) polymer and the other ingredient can be another poly(arylethersulfone) polymer. Said other ingredient can also be a polymer other than a poly(arylethersulfone) polymer such as polyvinylpyrrolidone and polyethylene glycol. It can also be a non polymeric ingredient such as a solvent, a filler, a lubricant, a mould release, an antistatic agent, a flame retardant, an anti-fogging agent, a matting agent, a pigment, a dye and an optical brightener.

All definitions and preferences provided in respect of the polymer composition in general also apply to the poly(arylethersulfone) polymer composition including at least one poly(arylethersulfone) polymer.

The invention also concerns an article comprising the polymer as above described or the polymer composition as above described.

The polymer and the polymer composition comprised in the article according to the present invention have the same characteristics respectively as the polymer and the polymer composition according to the present invention, in all their embodiments, as above detailed.

Non limitative examples of articles according to the present invention are: plumbing systems including a series of pipes, fittings, manifolds and valves that are used for the transportation of water or other fluids under pressure; medical instruments or parts of instruments (handles, viewing glasses), components of medical equipments that handle or dispense chemicals used in medical procedures (such as anesthesia), cases and trays used to hold such instruments all requiring cleaning and sterilization using steam, radiation, enzyme cleaners and/or chemical cleaners; food and beverage containers, including hot beverage storage containers and baby bottles; component of piping systems used for the collection or transportation of milk and other dairy products; funnels; filter device and other lab equipment; membranes.

The article is preferably a membrane. Membranes suitable for the purpose of the invention include, without limitation, isotropic or anisotropic membranes, porous or non-porous membranes, composite membranes, or symmetric or non-symmetric membranes. Such membranes may be in the form of flat structures, corrugated structures, (such as corrugated sheets), tubular structures, or hollow fibers.

Non limitative examples of membrane applications include water purification, wastewater treatment, pharmaceutical production, blood purification, in particular hemodialysis and a variety of industrial process separations, such as food and beverage processing, electropaint recovery and gas separation.

In a specific embodiment of the present invention, the article comprises the the poly(arylethersulfone) polymer as described above or the poly(arylethersulfone) polymer composition as described above.

The poly(arylethersulfone) polymer and the poly(arylethersulfone) polymer composition comprised in the article according to the present invention have the same characteristics respectively as the poly(arylethersulfone) polymer and the poly(arylethersulfone) polymer composition according to the present invention, in all their embodiments, as detailed above.

Should the disclosure of any patents, patent applications, and publications which are incorporated herein by reference conflict with the description of the present application to the extent that it may render a term unclear, the present description shall take precedence.

The invention will now be described in more details with reference to the following examples, whose purpose is merely illustrative and not intended to limit the scope of the invention.

### Example 1

### Preparation of diol (D-1): Hydroxysulfonebiphenyl (HSB)

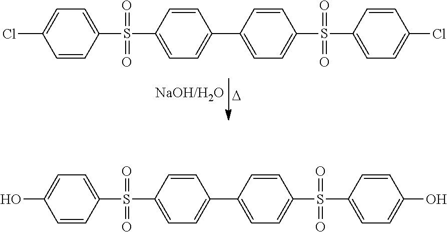

To a 1 L pressure-reactor, 125.85 g of chlorosulfonebiphenyl was added followed by sodium hydroxide (43.29) in 503.4 g water solution. The reactor was heated to 250-285° C. while being stirred at 175 rpm. The reactor developed 900-1000 psi pressure. The reaction mixture was held at the same temperature for 1 hr followed by rapid cooling to room temperature. The reaction mixture was diluted with 500 g water and filtered. The filtered solution was acidified carefully with conc. HCl to a pH of <2, with stirring. The heavy white precipitate was formed upon acid addition and the stirring was continued for 15 minutes. The crude product was filtered and repeatedly washed with deionized water until neutral. It was dried in a vacuum oven at 120° C. for 12 hours. The crude product yield was >98%. It was purified (>99% by LC) by crystallization from methanol in 80% yield. The structure was confirmed by ¹H NMR (mp-254° C., DSC).

### Example 2

### Polycondensation of Hydroxysulfonebiphenyl and 4,4′-dichlorodiphenylsulfone (DCDPS)

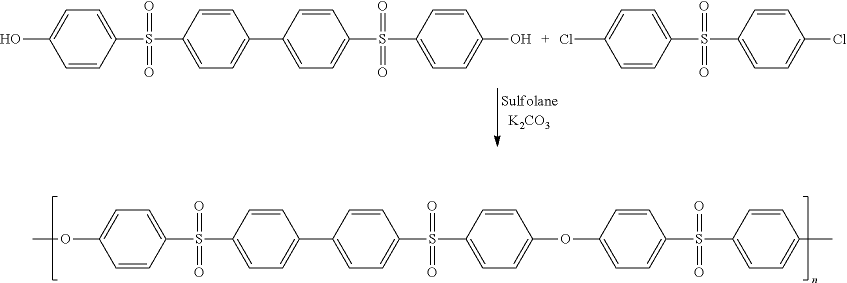

25.0 g of HSB, 15.62 g of 4,4′-dichlorodiphenylsulfone, 7.62 g of potassium carbonate (average particle size 32 μm), 85.12 g anhydrous sulfolane, and 28 g chlorobenzene was charged in a 250 ml, 4-necked round-bottomed flask. The reactor was equipped with an overhead mechanical agitator, nitrogen dip-tube, thermocouple, and a modified Barrett trap/condenser. The reactor contents were purged with nitrogen for 30 minutes. The temperature was raised to 215-220° C. while collecting water and chlorobenzene in the trap. The reaction mixture was held at temperature until the mixture was visibly viscous. 27 g of methyl chloride was bubbled through the reaction mixture over 30 minutes. The polymer reaction mixture was diluted with sulfolane and NMP followed by filtration to remove reaction salts. The filtered polymer solution was coagulated into 10× methanol followed by re-slurring with hot water, and dried in a vacuum oven at 120° C. for 12 hours. Mw (GPC): The weight average molecular weight (M_{w}) is 39,000 dalton and was measured by gel-permeation chromatography (GPC) using ASTM D5296 calibrated with polystyrene standards—Tg (DSC): Glass transition temperature (Tg) is 271° C. was determined by DSC, according to ASTM D3418.

### Example 3

### Preparation of diol (D-7): Bis-4-hydroxyphenoxydiphenylsulfone (HPS)

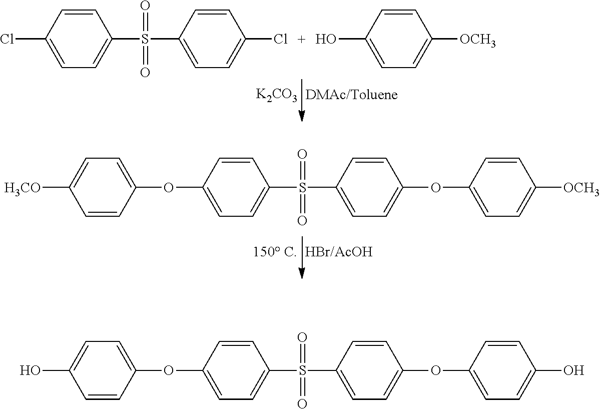

### A. Preparation of Bis(4-methoxyphenoxy)diphenylsulfone (MPS)

4,4′ dichlorodiphenylsulfone (132.18 g), 4-methoxyphenol (115.62 g), anhydrous potassium carbonate (160.00 g) were added to a 2 L 4-necked round-bottomed flask equipped with an overhead mechanical agitator, nitrogen inlet, Dean-Stark trap/condenser. DMAc (500 g) and toluene (460 g) were added to the flask. The stirring was started and the reaction mixture was heated to reflux (150° C.) for 21 hours and water was collected in the trap. The reaction temperature was increased to 160° C. and held for 15 hours until completion. The reaction mixture was cooled and the product was precipitated into deionized water. The tacky precipitated solid was dissolved in methylene chloride and extracted two times with deionized water. The methylene chloride solution was dried over anhydrous magnesium sulfate, filtered and treated with activated carbon. The solvent was removed by distillation, and the product was dried in a vacuum oven. The crude product yield was calculated to be 85%, (mp-107° C., DSC). The structure was confirmed by GC-MS. The purity was 95% determined by HPLC.

### B. De-methylation of MPS

MPS (40.0 g) was heated to reflux with 48% HBr (149.0 g) and glacial acetic acid (63 g) for 16 hours to affect de-methylation. The reaction mixture was cooled to RT and allowed to stand overnight to yield a precipitate. The precipitate was filtered and washed repeatedly with DI water to neutral pH. It was dried in a vacuum oven at 90° C. and recrystallized/decolorized from acetone and activated carbon. The purity was 98.2% determined by HPLC. The monomer structure was confirmed by NMR and LC-MS. DSC mp-195 C.

### Example 4

### Polycondensation of Bis-4-hydroxyphenoxydiphenylsulfone (HPS) and 4,4′-dichlorodiphenylsulfone (DCDPS)

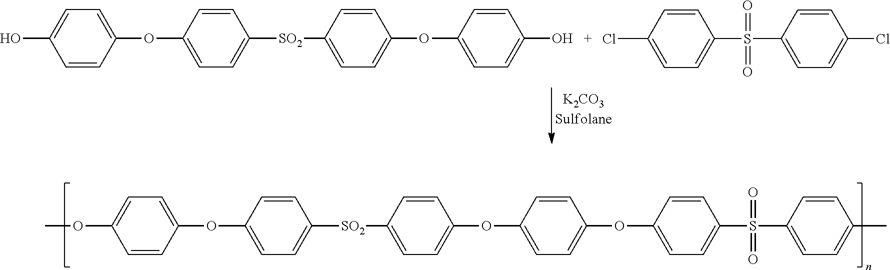

HPS monomer (19.81 g), DCDPS (13.07 g), anhydrous potassium carbonate (6.64 g), and sulfolane (87.6 g) was charged under nitrogen to a 250 ml 4-necked round-bottomed flask, equipped with nitrogen dip-tube, thermocouple, overhead mechanical agitator, a Dean-Stark trap with condenser. The temperature was raised to 210° C. and held for 12 hours until the reaction mixture became viscous. The water was collected in the trap. Methyl chloride was bubbled for 30 minutes at an approximate flow rate of 1 g/min. The reaction mixture was diluted with sulfolane/NMP and filtered to remove reaction salts. The polymer was recovered by coagulation into rapidly stirred methanol followed by drying in a vacuum oven at 130° C. for 24 hours. Mw (GPC): The weight average molecular weight (M_{w}) is 64,000 dalton and was measured by gel-permeation chromatography (GPC) using ASTM D5296 calibrated with polystyrene standards—Tg (DSC): Glass transition temperature (Tg) is 203° C. was determined by DSC, according to ASTM D3418.

### Example 5

### Preparation of diol (D-4): Preparation of Bis-4-hydroxyphenoxyphenylphosphine oxide (HPPPO)

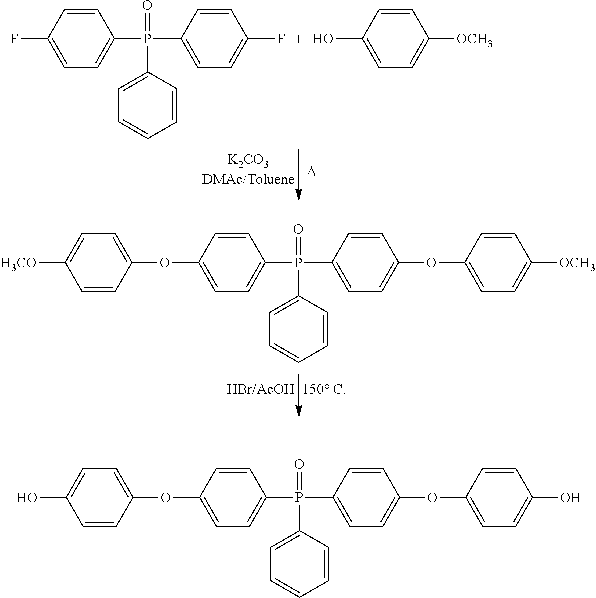

### A. Preparation of Bis-(methoxyphenoxy)phenylphosphine oxide (MPPPO)

To a 1 L 4-necked round-bottomed flask, equipped with a nitrogen dip tube, thermocouple, overhead mechanical agitator, Dean/stark trap/condenser, was charged Bis(4-fluorophenyl)phenyl phosphine oxide (72.05 g), p-methoxyphenol (57.88 g), anhydrous potassium carbonate (80.00 g), DMAc (140.55 g), and toluene (225 g). The reaction mixture was stirred and heated to establish reflux. The water was collected in the trap. The temperature was slowly increased to 160° C. until completion of the reaction. The crude ‘tacky’ product was recovered by the addition of 400 g deionized water to the cooled reaction mixture followed by filtration. The crude was dissolved in methylene chloride and extracted with deionized water. The organic layer was dried with anhydrous magnesium sulfate, treated with activated carbon, filtered and the solvent was distilled off to obtain an amber solid in 85% yield. (Purity (HPLC)—88%, mp—60° C., DSC).

### B. Preparation of Bis-(hydroxyphenoxy)phenylphosphine oxide (HPPPO)

MPPPO (100.0 g) was treated with a mixture of 48% HBr and glacial acetic acid (210 g) at reflux until demethylation was completed. Crude ‘tacky’ product precipitated upon cooling to room temperature. The acidic layer was decanted and the crude product solubilized with acetone. The acetone solution was stirred with 1000 g deionized water to afford a grey-white solid. The solid was filtered and repeatedly washed with deionized water until neutral. The solid was re-dissolved in acetone, dried with anhydrous magnesium sulfate, treated with activated carbon. The acetone volume was reduced and warm DI water was added until a slightly turbid solution could be obtained and allowed to crystallize. The white precipitate was filtered and further purified by DMSO/methanol mixture to a 79% yield. (Purity—96.3%, HPLC), mp—270° C., DSC). The structure was confirmed by ¹H NMR and LC-MS.

### Example 6

### Polycondensation of Bis-4-hydroxyphenoxyphenylphosphine oxide (HPPPO) and 4,4′-dichlorodiphenylsulfone (DCDPS)

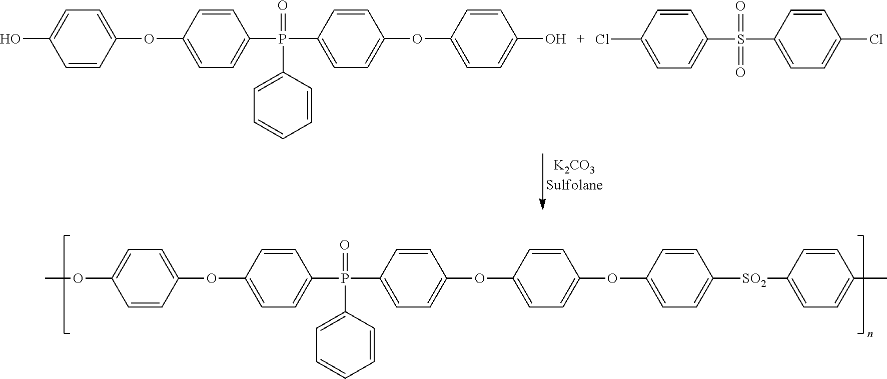

To a 250 ml 4-necked round-bottomed flask equipped with an overhead mechanical agitator, nitrogen dip-tube, thermocouple, and Dean-Stark trap/condenser; HPPPO (20.63 g), DCDPS (11.64 g), anhydrous potassium carbonate (5.95 g), and sulfolane (81.64 g) was added. The temperature was raised to 210° C. and held until the solution became viscous. The polymerization was terminated by bubbling methyl chloride (30 g) over 30 minutes. The reaction mixture was diluted with a mixture of sulfolane/NMP (40/60 w/w) and filtered to remove reaction salts. The polymer was isolated by coagulation into rapidly stirred methanol. The coagulum was re-slurried twice with hot water followed by methanol rinse and dried in a vacuum oven at 130° C. for 24 hours. Mw (GPC): The weight average molecular weight (M_{w}) is 77,000 dalton and was measured by gel-permeation chromatography (GPC) using ASTM D5296 calibrated with polystyrene standards—Tg (DSC): Glass transition temperature (Tg) is 211° C. was determined by DSC, according to ASTM D3418.

### Comparative Example 7

### Polycondensation of α,α′-Bis(4-hydroxyphenyl)-1,4-diisopropylbenzene (Bisphenol P) and 4,4′-dichlorodiphenylsulfone DCDPS

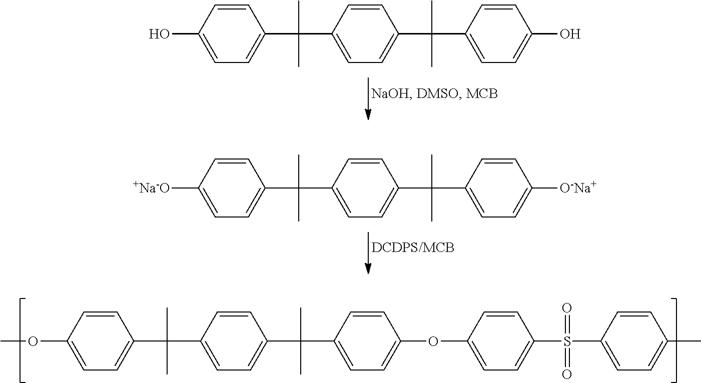

Bisphenol P (69.29 g), chlorobenzene (194 g) and DMSO (150.36 g) was added to a 500 ml 4-necked round-bottomed flask equipped a nitrogen dip-tube, overhead mechanical agitator, a modified Barrett-trap/condenser on top of a vigreux column. 31.08 g aqueous sodium hydroxide (˜50%) was slowly added to the reactor. The temperature was raised until a reflux was established and the reaction contents were dehydrated by collecting/removing water from the trap. Once all the water was removed, the temperature was raised to 155° C. A hot solution of DCDPS (57.43 g) and chlorobenzene (57.43 g) was slowly added to the reactor. The polymerization was allowed to proceed at 170° C. until the solution became viscous. The reaction mixture was diluted with chlorobenzene and cooled to 120° C. Methyl chloride was bubbled for 20 minutes with agitation. Small amounts of additional aqueous caustic can be added followed by methyl chloride addition to ensure efficient termination. The polymer reaction mixture was diluted with chlorobenzene, acidified with oxalic acid and filtered to remove reaction salts. The polymer solution was coagulated into rapidly stirred methanol. The recovered polymer was re-slurried twice with methanol, filtered and dried in a vacuum oven at 130° C. for 12 hours. Mw (GPC): The weight average molecular weight (M_{w}) is 58,000 dalton and was measured by gel-permeation chromatography (GPC) using ASTM D5296 calibrated with polystyrene standards—Tg (DSC): Glass transition temperature (Tg) is 184° C. was determined by DSC, according to ASTM D3418.

### Example 8

### Polycarbonate polymer by reaction of Bis-4-hydroxyphenoxyphenylphosphine oxide (HPPPO) and diphenyl carbonate

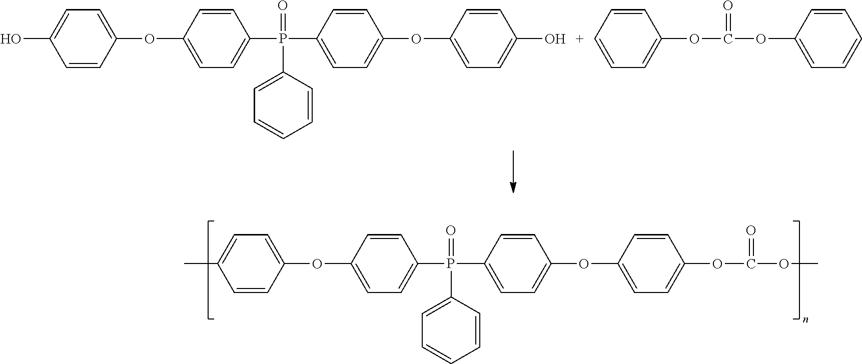

To a 500 mL 4-necked round-bottomed flask, equipped with an overhead mechanical agitator, nitrogen inlet, HPPPO (148.24 g) and diphenyl carbonate (71.59 g) are added. The powders are subjected to three high vacuum/nitrogen purge cycles. The reactor is heated using a high temperature oil bath at 180° C. with slow stirring until a homogenous melt is obtained. Tetraammonium hydroxide (0.007 g) is injected followed by catalytic amount of sodium hydroxide. The temperature is increased to 210° C. and the by-product phenol is vacuum distilled. The temperature and vacuum can be increased to maintain efficient phenol distillation. Once a viscous melt is obtained, full vacuum can be applied and the polymerization is allowed to proceed for 30 min to 1 hour. The polymer can be recovered by dissolving the polymer (after cooling) with an appropriate solvent such as methylene chloride and coagulation using a non-solvent such as methanol.

### Determination of the EC50 (nM) Response Value to the Estrogen Receptor α (ERα)

The response value “EC50” is measured by using the GeneBLAzer® Cell-Based Nuclear Receptor Assay technology which uses the GeneBLAzer® Betalactamase reporter technology, which is notably described in U.S. Pat. No. 5,955,604 incorporated herein by reference in its entirety.

The monomers (see Table 1) are dissolved in 100% DMSO at a concentration of 7 to 250000 nM.

ER-α-UAS-bla GripTite™ 293 cells are thawed and resuspended in Assay Media (DMEM phenol red free, 2% CD-treated FBS, 0.1 mM NEAA, 1 mM Sodium Pyruvate, 100 U/mL/100 μg/mL Pen/Strep) to a concentration of 625,000 cells/mL. 4 μL of a 10 times serial dilution of 17-beta-Estradiol (control agonist starting concentration, 10 nM) or monomers of the present invention (see table 1) are added to appropriate wells of a 384-well TC-Treated assay plate. 32 μL of cell suspension (20,000 cells) is added to each well. 4 μL of Assay Media is added to all wells to bring the final assay volume to 40 μL. The plate is incubated for 16-24 hours at 37° C./5% CO2 in a humidified incubator. 8 μL of 1 μM Substrate Loading Solution, obtained from Invitrogen™ is added to each well and the plate is incubated for 2 hours at room temperature. The plate is read on a fluorescence plate reader.

The following equations are used for each set of data points:

### (1) Background-Subtracted Fluorescence (Fl=Fluorescence Intensity):

Fl_{Sample}−Fl_{Cell-Free Ctrl}

(2) Emission Ratio (using values corrected for background fluorescence):

Coumarin Emission (460 nm)/Fluorescein Emission (530 nm)

### (3) Response Ratio:

Emission Ratio_{Compound}/Emission Ratio_{No Stim Ctrl}

### (4) % Activation—Agonist Assays:

(Response Ratio_{Compound}−Response Ratio_{No Stim Ctrl}/Response Ratio_{Full Stim Ctrl}−Response Ratio_{No Stim Ctrl})*100

The experimental data points were fit to a sigmoid dose response curve using the XLfit™ program from IDBS:

$$RESPONCE = L + \frac{U - L}{1 + {( \frac{C}{x} )}^{Hillslope}}$$

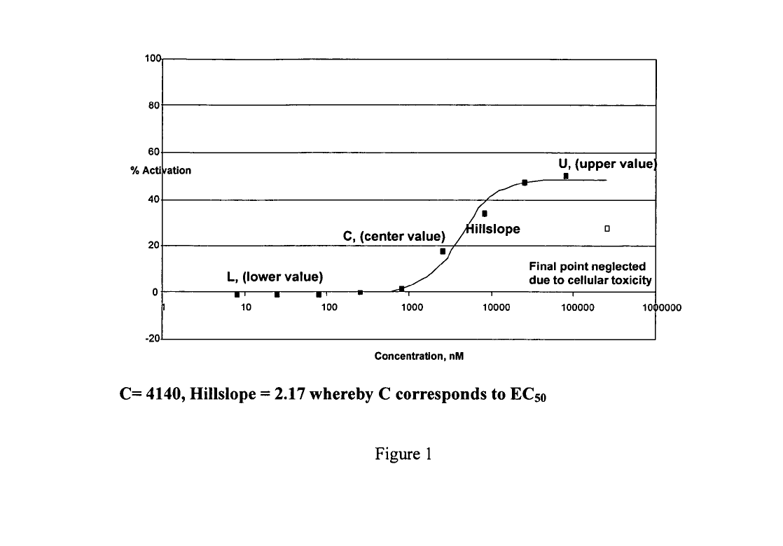

The graphic curve for the compound Bisphenol S is shown in FIG. 1.

The experimental data are summarized in Table 1

| | | Interatomic distance |
|---|---|---|
| | EC50 | between the two O atoms |
| | (nM) | of the 2 OH groups (¹) |
| Estradiol E2 | 0.087 | 10.71 |
| Example 1 (HPS) | >79 100 | 17.03 |
| Example 3 (HBS) | >79 100 | 14.47 |
| Example 5 | >250 000 | 16.48 |
| (HPPPO) | | |
| BisP | >25 000 | 12.62 |
| Bisphenol A | >25 000 | 9.23 |
| Bisphenol S | 4140 | 9.67 |

(¹) The interatomic distance between the two O atoms of the OH groups of the diol monomers has been determined by using the CS Chem3D Pro, Molecular Modeling and Analysis program, version 7.0. CS Chem3D Pro is a program with many parts, including especially a module package able to carry out interatomic distance calculations. The following steps were carried out: (1) an image of the corresponding monomer was created and displayed as images of molecular models in a way that it communicated the arrangement of atoms in space on the screen; (2) the corresponding energy was calculated and minimized by adjusting the atomic positions using “Molecular Mechanics” (not quantum mechanics); (3) after energy minimization the interatomic O—O distance between the two OH groups was measured.

1-7. (canceled)

8. A membrane comprising a polymer or a polymer composition, wherein said polymer is a poly(arylethersulfone)polymer comprising recurring units derived from at least one aromatic dihalo monomer comprising at least one —S(═O)₂— group or a polycarbonate polymer comprising recurring units derived from a carbonate compound selected from the groups consisting of a carbonyl halide, a carbonate ester and a haloformate; and an aromatic diol (D) having general formula (III)
HO—Ar¹-Q-Ar²—OH (III)
wherein Ar¹, Ar² are equal or different from each other and are aromatic moieties of the formula: 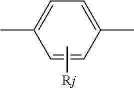
wherein R is selected from the group consisting of:
hydrogen, halogen, alkyl, alkenyl, alkynyl, aryl, ether, thioether, carboxylic acid, ester, amide, imide, alkali or alkaline earth metal sulfonate, alkyl sulfonate, alkali or alkaline earth metal phosphonate, alkyl phosphonate, amine and quaternary ammonium and j is 0, 1, 2, 3 or 4.
wherein Q is a group chosen among the following structures (Q-1), (Q-2), (Q-3), (Q-4), (Q-5), (Q-6) and (Q-7): 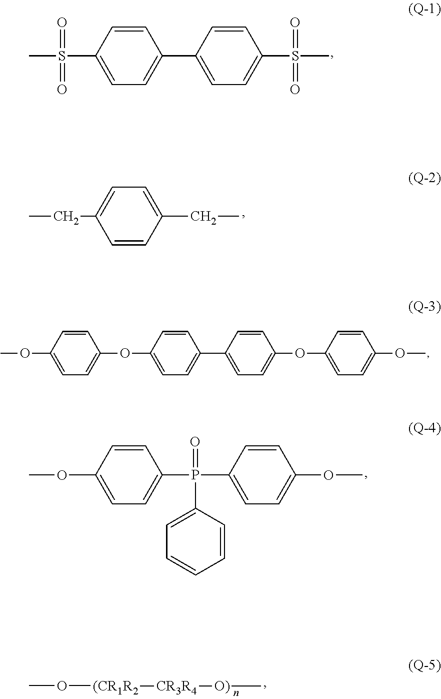
in which R₁, R₂, R₃, and R₄ equal to or different from each other, are independently selected from H, an alkyl group having from 1 to 10 carbon atoms which is optionally substituted by at least one halogen atom, an aralkyl group or an aryl group; n iso, 1, 2, 3, 4, 5 or 6; 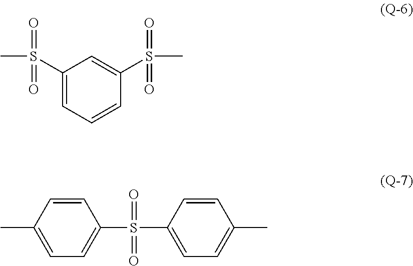
and wherein the polymer composition is comprising said poly(arylethersulfone)polymer or said polycarbonate polymer and at least one other ingredient.

9-10. (canceled)

11. The membrane according to claim 8, wherein the aromatic diol (D) is selected from the group consisting of those complying with formulae (D-1), (D-2), (D-3), (D-4), (D-5), (D-6) and (D-7): 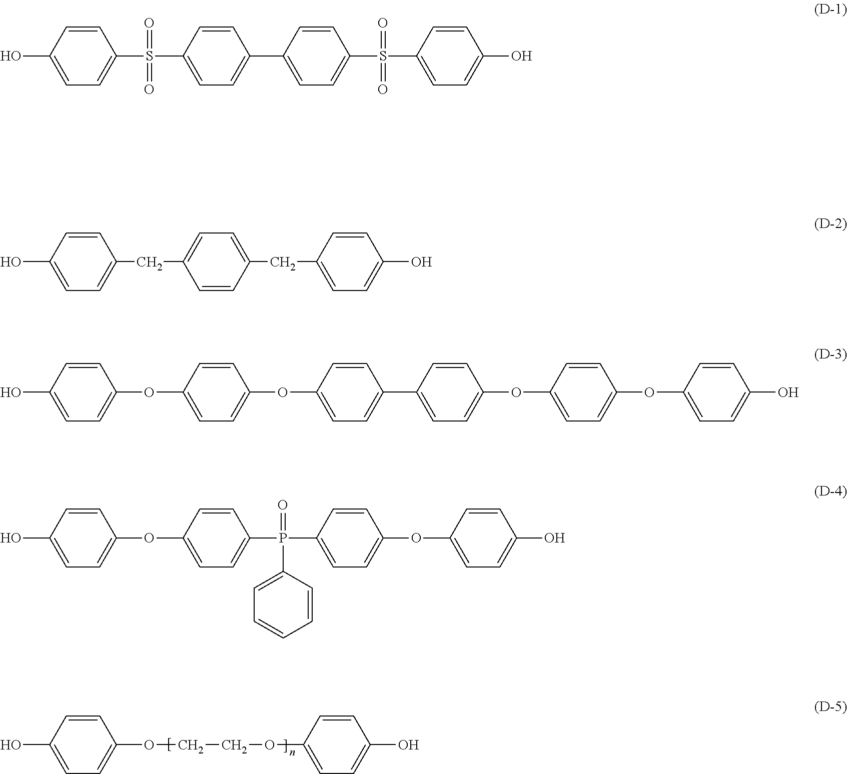
wherein n is 0, 1, 2, 3, 4, 5 or 6;

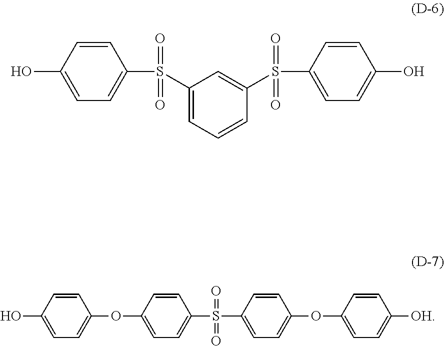 [SMILES: O=S(=O)(c1ccc(O)cc1)c1cccc(S(=O)(=O)c2ccc(O)cc2)c1 ; O=S(=O)(c1ccc(Oc2ccc(O)cc2)cc1)c1ccc(Oc2ccc(O)cc2)cc1]

12-15. (canceled)

16. The membrane according to claim 8, wherein the wherein the polymer composition is a dope solution

17-18. (canceled)

19. An aromatic diol (D) according to formula (D-3):

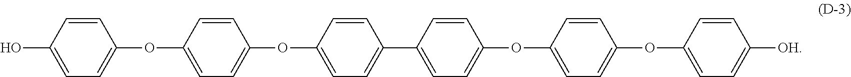 [SMILES: Oc1ccc(Oc2ccc(Oc3ccc(-c4ccc(Oc5ccc(Oc6ccc(O)cc6)cc5)cc4)cc3)cc2)cc1]

20. (canceled)

21. The membrane according to claim 8, wherein the membrane is selected from the group consisting of isotropic or anisotropic membranes, porous or non-porous membranes, composite membranes, symmetric membranes and non-symmetric membranes.

22. The membrane according to claim 8, wherein the membrane is in the form of flat structures, corrugated structures, tubular structures, or hollow fibers.

23. A method for the manufacturing of the membrane according to claim 1, comprising casting or spinning of a solution of the polymer.

24. The membrane of claim 8, wherein the membrane is suitable for application in water purification, wastewater treatment, pharmaceutical production, blood purification, or industrial process separations.

25. The membrane of claim 24, wherein the blood purification is hemodialysis.

26. The membrane according to claim 24, wherein the industrial process separation is a separation in food and beverage processing.

27. The membrane according to claim 24, wherein the industrial process separation is a separation in electropaint recovery.

28. The membrane according to claim 24, wherein the industrial process separation is a gas separation.
